(19) United States
(12) Patent Application Publication
(10) Pub. No.: US 2026/0243794 A1
(43) Pub. Date: Aug. 20, 2026

(54) ROBOTIC PIPETTES CALIBRATION SYSTEM, METHOD OF USE, AND AUXILIARY DEVICES

(71) Applicant: QCC HAZOREA CALIBRATION TECHNOLOGIES A.C.S LTD., Kibburz Hazorea (IL)

(72) Inventors: Uri MAURICE, Kibbutz Hazorea (IL); Or SHOVAL, Kibbutz Megiddo (IL)

(21) Appl. No.: 19/161,336

(22) PCT Filed: Mar. 5, 2024
(86) PCT No.: PCT/IL2024/050234

§ 371 Date: Sep. 2, 2025

Related U.S. Application Data
(60) Provisional application No. 63/450,042, filed on Mar. 5, 2023.

(51) Int. Cl. G01N 35/10; G01N 35/00

(52) U.S. Cl. CPC G01N 35/1016; G01N 35/00693; G01N 35/0099; G01N 2035/00891; G01N 2035/103

(57) ABSTRACT

A system and method for semi-automatic pipette calibration of any air-displacement type of pipette in a time efficient manner. The system including a pipette holder configured to carry a plurality of pipettes, each of the plurality of pipettes adjusted to aspirate water of a specific calibration volume; a robotic arm comprising a gripper configured to hold any air-displacement type of pipette, a tip storage compartment comprising multiple different sized cells configured to carry different sized tip cartridges for holding a different size of tips; a tip cartridge bay configured to fixate the cartridge at a specific location within the cartridge bay; a water basin; at least one scale for weighing water extracted from the water basin by each of the plurality of pipettes; a control system; and a user interface configured to display information related to the semi-automatic calibration.

### FIELD OF THE DISCLOSURE

The present disclosure relates to a system and method for calibrating multiple piston-operated volumetric apparatuses, particularly for calibrating handheld pipettes.

### BACKGROUND OF THE DISCLOSURE

Many types of pipettes are currently used in various fields, all for the same purpose of quantifying a specific and predefined volume of liquid. The variations between the different types of pipettes may include size, maximum and minimum volumes, accuracy, adjustment mechanism, and operating mechanism, which may, in some pipettes, be an electrical or mechanical air-displacement (Vacuum) mechanism.

A pipette connects to a tip, which may be disposable and into which the liquid may be aspirated.

Since a pipette is a mechanical device, its accuracy and precision decreases with time and due to extended usage. It requires calibration every predefined period, e.g., annually. Calibration must comply with standards valid for the relevant jurisdiction. Pipettes are currently calibrated worldwide according to specific calibration requirements as defined by international standards such as ISO 17025 and ISO 8655. The presently common method described in these standards is the Gravimetric Method. The standards require a manual and relatively long procedure, which includes examining the function of each pipette and for an adjustable pipette, performing three batches of measurements with different preset volumes to reach at least 30 iterations of measurements per pipette. In case of discrepancies, additional batches may be required. Accordingly, pipette calibration may take even a proficient employee about 20 to 40 minutes, resulting in calibration of an average of 10 to 14 pipettes per workday.

It is thus desirable to provide a semi-automatic system and method that would significantly reduce time, workforce, and errors that may occur during a fully manual calibration process.

### SUMMARY OF THE DISCLOSURE

An aspect of an embodiment of the disclosure relates to a system and method for semi-automatic calibration of substantially any air-displacement type pipettes, whether they differ in size, shape, operating mechanism, and the like. It further relates to enabling the calibration of a plurality of pipettes in batches with minimal human intervention to save time and labor. It further relates to providing a significantly more reliable calibration process than current manual calibration methods.

According to some embodiments, the present disclosure provides a method for calibration of a plurality of pipettes of any air-displacement type, compatible with the International Standard ISO 8655-6:2022. The order of operations as well as the nature of the different operations themselves, may change based on changing requirements of the standards which may be updated from time to time. The method may comprise:
(a) adjusting a first calibration volume in each of the plurality of pipettes, said adjusting is performed manually;
   by an automated system, e.g., a robotic arm:
(b) extracting a pipette from a pipette holder;
(c) attaching a corresponding tip to a pipette distal end, e.g., by pushing a pipette distal end into a predetermined corresponding tip for connecting the tip to the pipette;
(d) immersing a tip distal end into a water dispenser, e.g., at a depth determined based on the first calibration volume;
(e) aspirating water from the water dispenser into the tip according to the adjusted first calibration volume;
(f) extracting the water from the tip onto a scale;
(g) weighing the extracted water by the scale;
(h) repeating operations (d)-(g) for a predetermined number of times;
(i) after completion of operations (d)-(g) for the predetermined number of times, removing the tip from the pipette;
(j) calculating average volume of the water of operations (d)-(g) by a processor, the volume of the water may be a calculated as a function of the measured water weight, water density and other factors;
(k) repeating operations (c)-(j) for another predetermined number of times;
(l) returning pipette back into the pipette holder by the robotic arm; and
(m) repeating operations (b)-(l), by the robotic arm, until all of the plurality of pipettes are calibrated per the first calibration volume.

Optionally, the plurality of pipettes comprises at least 15 pipettes.

Optionally, in case the pipette is not a single volume pipette, the method further comprising adjusting a second calibration volume in each of the plurality of pipettes, said adjusting is performed manually;
repeating operations (b)-(l) until all of the plurality of pipettes are calibrated per the second calibration volume;
adjusting a third or any preceding calibrating volume in each of the plurality of pipettes, said adjusting is performed manually; and
repeating operations (b)-(l) until all of the plurality of pipettes are calibrated per the third or any preceding calibration volume.
1. Optionally, the method further comprising adjusting additional calibrating volumes in each of the plurality of pipettes, said adjusting is performed manually; and
repeating operations (b)-(l) until all of the plurality of pipettes are calibrated per the additional calibration volume.

Optionally, the method further comprising collecting environmental data via sensors, said sensors comprising air temperature sensor, humidity sensor, air pressure sensor, water conductivity sensor, water temperature sensor or any combination thereof. The data may be automatically transferred from the sensors to a controller, e.g., a computer.

Optionally, the method further comprises using the collected environmental data for the calculations of each calibration water volume.

Optionally, the immersing a tip distal end into a water dispenser is done at a depth determined based on the first calibration volume and corresponding to a relevant ISO standard.

In some embodiments, the method further comprises selecting one of two scales, based on the adjusted calibration volume, e.g., prior to operation (f).

In some embodiments, the method of claim 1, further comprising mapping the pipette distal end location with respect to the robotic arm following operation (b) and prior operation (c).

In some embodiments, the method of claim 1, further comprising determining tip distal end location with respect to the robotic arm following operation (c).

In some embodiments, the method may comprise uploading pipette parameters per location in pipette holder, prior to operation (a).

Optionally, the aspirating water from the water dispenser into the tip comprises controlling application of a force on a pipette plunger to displace air or liquid from the pipette with water from the water dispenser, by a force sensor.

Optionally, the aspirating water from the water dispenser into the tip comprises depressing a pipette plunger to end of a first range and controlling application of a depressing force on the pipette plunger by a force sensor, and releasing the pipette plunger to displace air from the pipette with water from the water dispenser

Optionally, the method further comprising wiping excess water droplets off the external side of the pipette tip against a wall situated above the water basin.

Optionally, extracting the water from the tip onto a scale comprises controlling application of a force on a pipette plunger to displace water from the pipette with air, by a pressure sensor.

Optionally, the extracting the water from the tip onto a scale comprises depressing a pipette plunger to end of a second range and controlling application of a force on the pipette plunger to displace water from the pipette with air, by a pressure sensor, and drawing the distal end of the tip along an inner wall of a weighing vessel positioned on the scale.

Optionally, repeating operations (e)-(g) for a predetermined number of times comprises repeating operations (e)-(g) five times.

Optionally, after removing the tip from the pipette, repeating operations (c)-(g), thereby completing at least ten measurements per each calibration volume.

In some embodiments, the method further comprising uploading pipette parameters per location in pipette holder, prior to operation (a).

Optionally, extracting a pipette from a pipette holder comprises identifying the pipette by the location of the pipette in the pipette holder.

Optionally, the method further comprising placing a tip cartridge, by the robotic arm, at a cartridge bay, and fixating the cartridge at a specific location within the bay, via jaws that push the cartridge to a specific corner in the cartridge bay, prior to operation (b).

Optionally, the method further comprising returning said cartridge to its allocated cell in the tip storage compartment prior to placing a different cartridge in the cartridge bay.

Optionally, the method further comprising extracting a tip cartridge from a corresponding cell of a tip storage compartment prior to placing the tip cartridge at a cartridge bay.

In some embodiments, the method further comprising extracting an empty tip cartridge from the cartridge bay and replacing it with a new cartridge carrying the type of tip that corresponds to the type of pipette extracted in operation (b).

Optionally, the method further comprising refilling the water dispenser with water after operation (e).

Optionally, following operation (k), the calculated average volume of the water per each batch of measurements of the predetermined number of times, are compared, and if a difference between the two calculated average volumes of the water is above a predefined threshold, the method comprises repeating operations (d)-(j) for a third predetermined number of times, and by comparing each of the first two calculated average volume of water to the third calculated average volume of water, determining which of the first two batches of measurements is related to a faulty tip and which is to an intact tip.

There is provided a system for calibration of a plurality of pipettes of any air-displacement type, compatible with the International Standard ISO 8655-6:2022, the system comprising: a pipette holder configured to carry a plurality of pipettes of any air-displacement type, each of the plurality of pipettes adjusted to aspirate water of a specific calibration volume;
a robotic arm comprising a gripper configured to hold any air-displacement type of pipette, the gripper comprising two moveable arms, each having a non-rigid face that comes in contact with a pipette, wherein the moveable arms are configured to contract for gripping a pipette in between the two non-rigid faces of the moveable arms, and to expand for releasing the pipette from the gripper;
a water dispenser;
at least one scale for weighing water extracted from the water dispenser by each of the plurality of pipettes;
a control system; and
a user interface configured to display information related to calibration.

Optionally, the plurality of pipettes comprises at least 15 pipettes.

In some embodiments, the system further comprises a tip storage compartment comprising multiple different sized cells, each cell comprising at least one tip cartridge, wherein the different sized cells are configured to carry different sized tip cartridges for holding a different size of tips;
a tip cartridge bay comprising at least two jaws that push the cartridge to a specific corner in the cartridge bay, to thereby fixate the cartridge at a specific location within the cartridge bay.

Optionally, the system comprises one or more of: a tip storage compartment comprising multiple different sized cells, each cell comprising at least one tip cartridge, wherein the tip storage compartment has an arched shape, such that distance of the robotic arm from each cell of the tip storage compartment is similar;
a tip storage compartment comprising multiple different sized cells, each cell comprising at least one tip cartridge, wherein each cell is positioned at an angle with respect to a floor of the system, to enable sliding of a tip cartridge towards a cell entrance;
a tip storage compartment comprising multiple different sized cells, each cell comprising at least one tip cartridge, wherein at least one cell entrance comprises a stopper, said stopper comprising a raised extension of a bottom side of the cell, to prevent the tip cartridge from slipping out of the cell entrance;
a tip storage compartment comprising multiple different sized cells, each cell comprising at least one tip cartridge, wherein each cell comprises rails positioned on opposite sides of a bottom side of the cell, to enable the tip cartridge within the cell to slide on top of the rails and reach a cell entrance.

Optionally, the pipette holder is a carousel configured to carry multiple, e.g., at least 15 pipettes of any air-displacement type. The carousel may be configured to carry a larger number of pipettes thereon.

Optionally, the pipette holder comprises a plurality of hangers per each of the plurality of pipettes, onto which the pipettes may be hanged or attached.

Optionally, the pipette holder comprises a motor configured to rotate the carousel pipette holder.

Optionally, the robotic arm is a six-axis articulated robotic arm.

In some embodiments, the robotic arm further comprises an accurate linear actuator and a force sensor configured to control application of a force applied by the accurate linear actuator on a pipette plunger for aspirating water from the water basin and for extracting the aspirated water into the at least one scale.

Optionally, the robotic arm further comprises a cylinder configured to press on a tip release button of the pipette for releasing a tip from the pipette.

Optionally, the robotic arm further comprises a vacuum gripper configured to carry a tip cartridge by attaching the vacuum gripper to one face of the tip cartridge, via vacuum.

Optionally, water dispenser comprises a drain opening for removing excess water, the water dispenser refilled to maintain a specific water level before every water extraction from the water dispenser.

Optionally, the tip storage compartment has an arched shape, such that distance of the robotic arm from each cell of the tip storage compartment is similar.

Optionally, each cell is positioned at an angle with respect to a floor of the system, to enable sliding of a tip cartridge towards a cell entrance.

Optionally, the cell entrance comprises a stopper comprising a raised extension of a bottom side of the cell, to prevent the tip cartridge from slipping out of the cell entrance.

Optionally, each cell comprises rails positioned on opposite sides of a bottom side of the cell, to enable the tip cartridge within the cell to slide on top of the rails and reach a cell entrance.

Optionally, the water dispenser is fluidically connected to a clear water reservoir, and the water dispenser may be refilled from the clear water reservoir after every aspiration to maintain a specific water level before every water extraction from the water dispenser.

Optionally, the at least one scale comprises two scales that differ in scale resolution and range, each configured to weigh a different water calibration volume.

Optionally, the system for calibration of a plurality of pipettes of any air-displacement type further comprises a water drainage system for draining water from the at least one scale to ensure the water vessel over the scale is not overfilled with water by the repetitive water extraction into the vessel, wherein said drainage system is deployed to the water vessel on demand and retracted when unused to prevent waterdrops that may affect the measurement accuracy;

Optionally, the controller is configured to control operation of the robotic arm and possibly the tip cartridge bay.

Optionally, the user interface provides notifications to the user.

Optionally, the notifications comprise notifications of end of calibration of the plurality of pipettes, malfunction of the calibration process, water level in a water container is below a predetermined threshold, environmental conditions are above a predetermined threshold, pipette is not grasped by a robotic arm, tip is not found after attachment to pipette, pipette holder is not moving, water emptying system malfunction, water purity does not meet predetermined conditions, missing tip per pipette in the tip storage compartment, operator door is open, end of batch and operator is required to adjust a new calibration volume, end of final round, report signature is missing, or any combination thereof.

Optionally, the system further comprising a bin for used tips and empty tip cartridges.

Optionally, the system further comprising a sensing unit used to determine location of pipette and tip distal end relative to the robotic arm.

Optionally, the sensing unit comprises a beam emitter and a photoelectric sensor.

There is provided a tray for connecting to a tip cartridge, the tray comprising: a horizontal sheet connected to a longitudinal sheet to create an L shape, wherein the horizontal sheet of the L shaped tray is connected to a bottom end of a tip cartridge, and the longitudinal sheet of the L shaped tray is in contact with a side of the tip cartridge, further wherein the longitudinal sheet is flat at least on its external side, such to enable grip of the L shaped tray by vacuum, thereby to enable any type and size of tip cartridge to be carried by a vacuum gripper via the tray.

Optionally, the horizontal sheet is flat and is configured to slide along corresponding rails of each cell of a tip storage compartment.

Optionally, the horizontal sheet is connected to the bottom end of the tip cartridge via adhesive.

Optionally, the longitudinal sheet is connected to the side of the tip cartridge via adhesive.

Optionally, the tray is made of plastic.

### BRIEF DESCRIPTION OF THE DRAWINGS

The present disclosure will be understood and better appreciated from the following detailed description taken in conjunction with the drawings. Identical structures, elements, or parts that appear in more than one figure are generally labeled with the same or similar number in all the figures in which they appear, wherein:

FIG. 1 is a schematic illustration of a top-view of a system for calibration of a plurality of pipettes of substantially any air-displacement type, according to embodiments of the disclosure;

FIG. 2 is a schematic illustration of a side-view of system for calibration of a plurality of pipettes encapsulated behind a closed container, according to embodiments of the disclosure;

FIG. 3A is a schematic illustration of a pipette holder, according to embodiments of the disclosure;

FIG. 3B is a schematic illustration of a pipette hanger that is attached to the pipette holder, according to embodiments of the disclosure;

FIG. 3B′ is a schematic illustration of a pipette hanger that is configured to be attached to the pipette holder, according to embodiments of the disclosure;

FIG. 3C is a schematic illustration of a subsystem extending a pipette toward the robotic arm, according to embodiments of the disclosure;

FIG. 4 is a schematic illustration of a tip storage compartment, according to embodiments of the disclosure;

FIG. 5 is a schematic illustration of a tip cartridge bay, according to embodiments of the disclosure;

FIG. 6 is a schematic illustration of a water dispenser, according to embodiments of the disclosure;

FIG. 7A is a schematic illustration of a laser photoelectric sensor apparatus, according to embodiments of the disclosure;

FIG. 7B is a schematic illustration of parameters used for calculations to determine objects' location and orientation, such as the pipette distal end or the tip distal end, according to embodiments of the disclosure;

FIGS. 8A-8C are schematic illustrations of a front perspective view, a bottom perspective view, and a side view, respectively, of a robotic arm gripper, according to embodiments of the disclosure;

FIG. 9 is a schematic illustration of a robotic arm gripper holding a tips cartridge, according to embodiments of the disclosure;

FIGS. 10A-10B are schematic illustrations of a tray before and after it is connected to a tip cartridge, respectively, according to embodiments of the disclosure;

FIG. 11 is a schematic illustration of a water drainage system for draining water from the scales, according to embodiments of the disclosure; and,

FIGS. 12A-12E describe schematic flow charts illustrating methods for calibration of pipettes of substantially any air-displacement type, according to embodiments of the disclosure.

### DETAILED DESCRIPTION

According to the present disclosure, as used herein, the term “an accurate linear actuator” refers to any linear actuator that efficiently and effectively allows precise control of its movement. An accurate linear actuator may typically be a hydraulic cylinder or an electro-mechanical actuator, though other options are possible. An accurate linear actuator may include a force sensor to measure the opposing force applied as it advances or retracts.

As used herein, the term “linear actuator”, if not defined as accurate, may typically refer to a pneumatic cylinder as it is a cost-effective and efficient solution when high-precision movement control is unnecessary. However, it is possible to use other linear actuators instead.

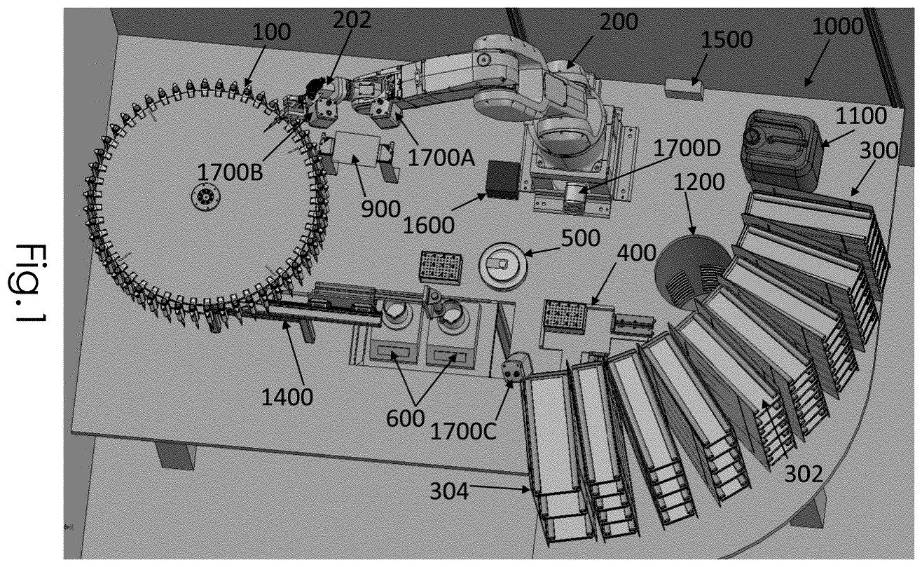

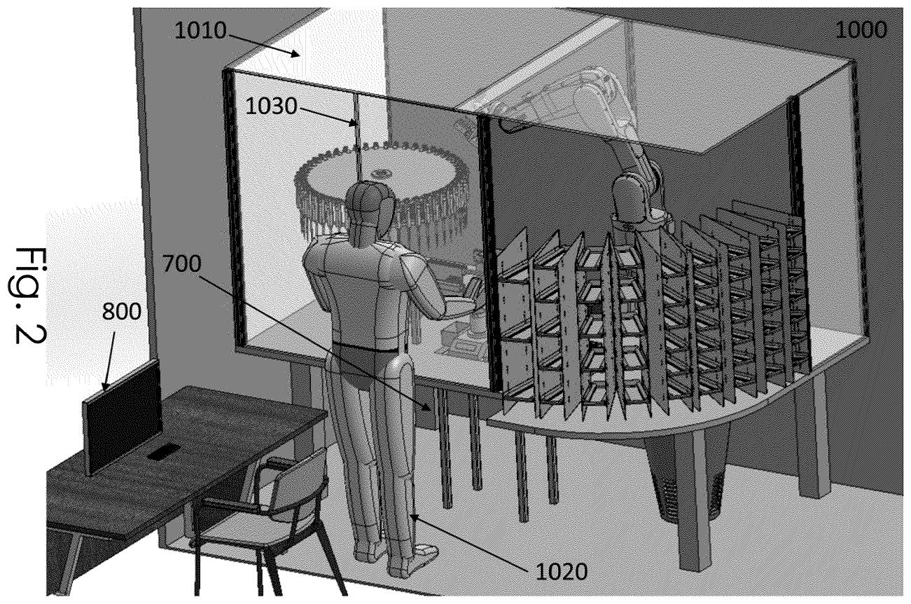

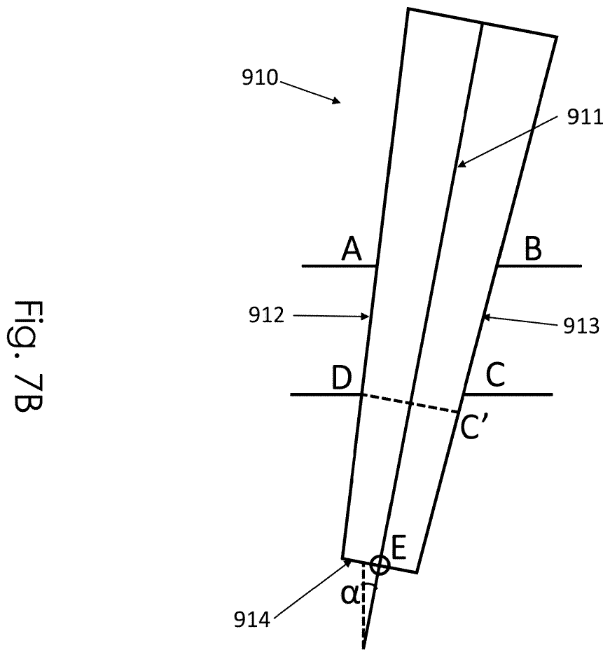

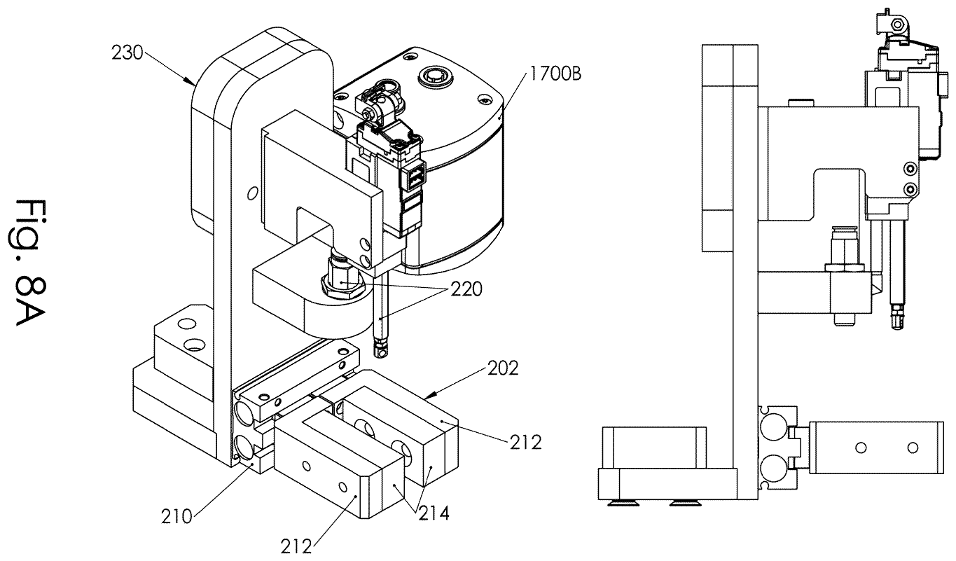

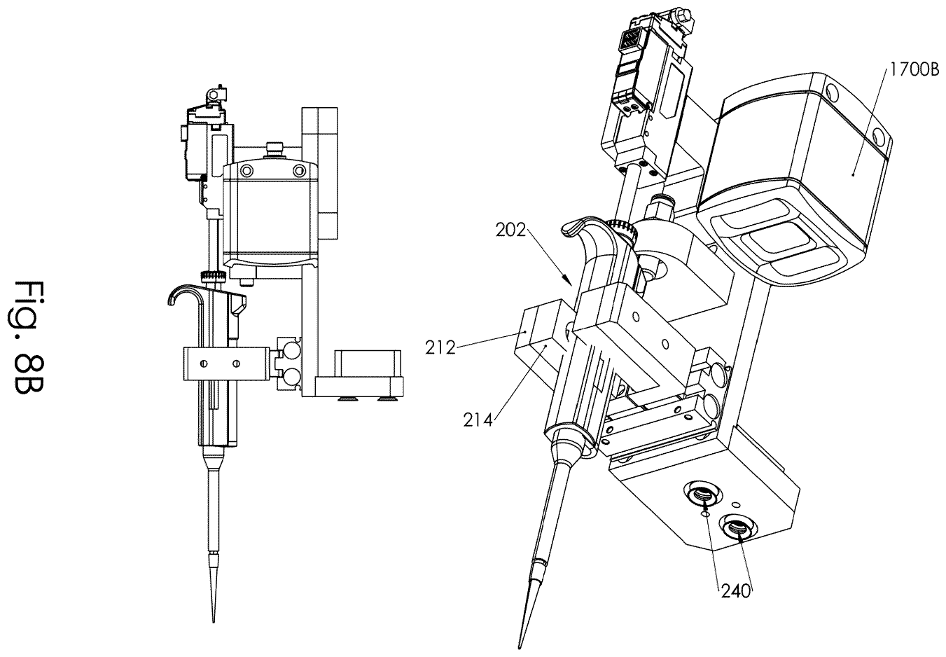

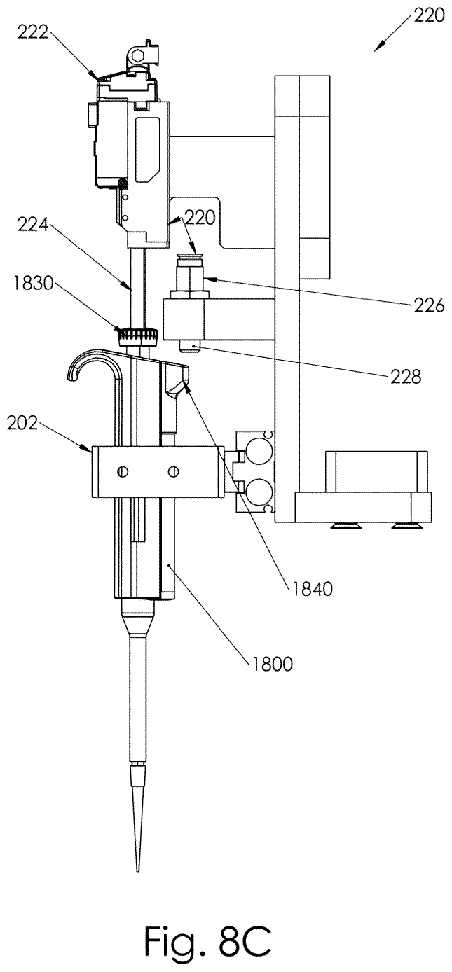

Reference is now made to FIG. 1, which is a schematic illustration of a top-view of a system for calibrating a plurality of substantially any air-displacement type pipettes, in accordance with embodiments of the disclosure. Calibration system 1000 may be compatible with the International Standard ISO 8655-2:2022. Calibration system 1000 may be may comprise a pipette holder 100 configured to hold a plurality of pipettes, which may be of different types with respect to size, shape, and operating mechanism. Calibration system 1000 may further comprise a robotic arm 200 that is controlled by a controller 700 (FIG. 2), e.g., a computer. The robotic arm 200 may be a 6-axis articulated robot, which may comprise, as will be detailed herein below (FIGS. 8A-9), one or more of (i) a pipette gripper configured to hold and maneuver a pipette during the calibration procedure, (ii) vacuum grippers to grip and carry a tip cartridge, (iii) an actuator to apply force on the pipette plunger to aspirate the predefined calibration water volume into the pipette tip; (iv) an actuator to release the tip from the pipette; and possibly (v) a designated imaging device, e.g., a camera, configured for mapping tip cartridges to enable finding the precise location of any tip in the cartridge.

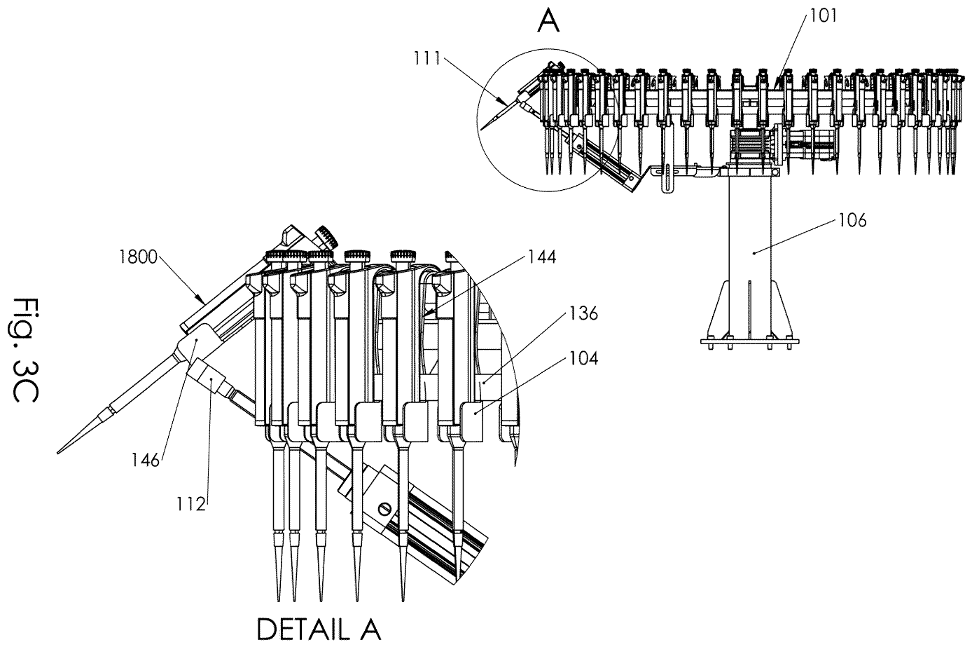

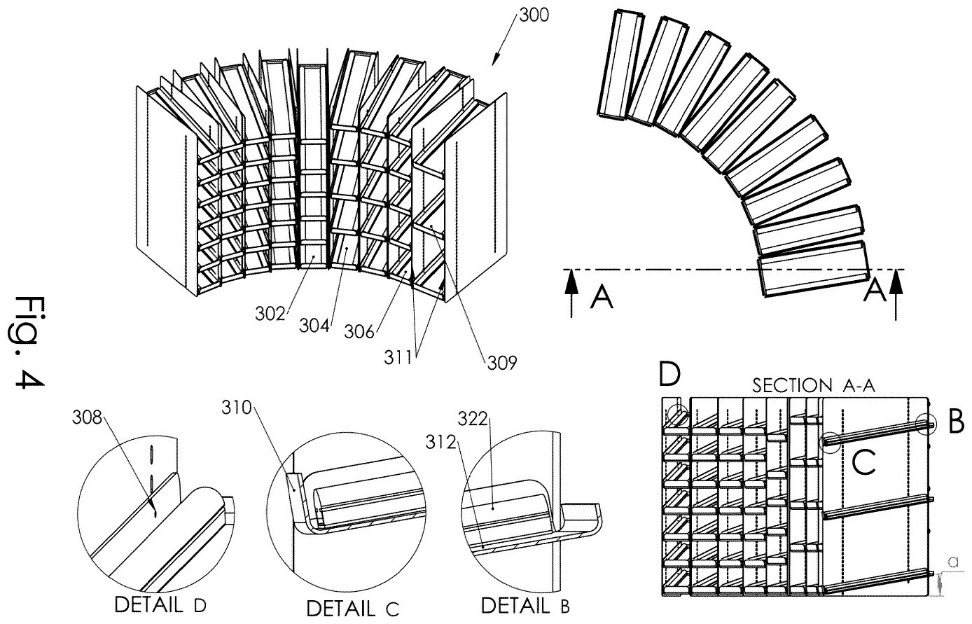

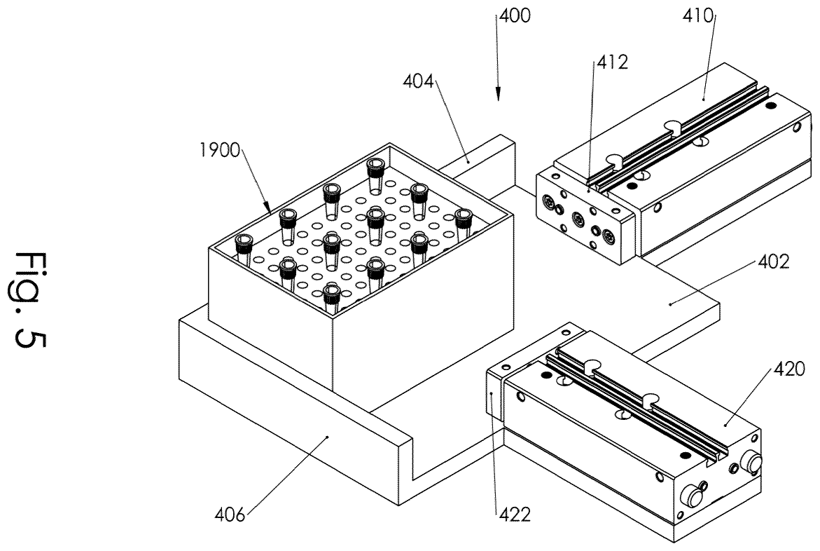

Robotic arm 200 is configured to pick a pipette from the pipette holder 100 and connect a corresponding tip to the picked pipette. The pipette held by the robotic arm 200 picks a tip from a tip cartridge 1900 fixated at a tip cartridge bay 400 (detailed in FIG. 5). The tip cartridges 1900 are kept in a tip storage compartment 300 (FIG. 4) before being placed into the tip cartridge bay 400. The robotic arm 200 is further configured to operate the pipette to aspirate a predefined volume of water from a water dispenser 500 (FIG. 6) into the pipette's connected tip and to extract the predefined water volume onto a scale 600, typically into a beaker pre-positioned onto the scale 600. In some embodiments, there may be two or more scales 600, which may differ in resolution and dynamic range to cover a broader range of pipettes configured to aspirate different volumes.

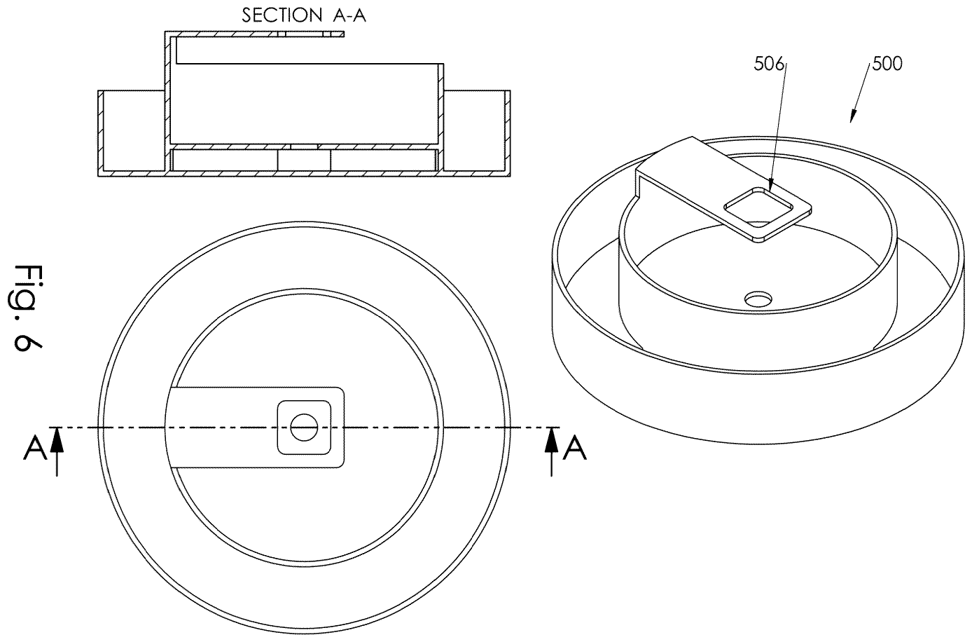

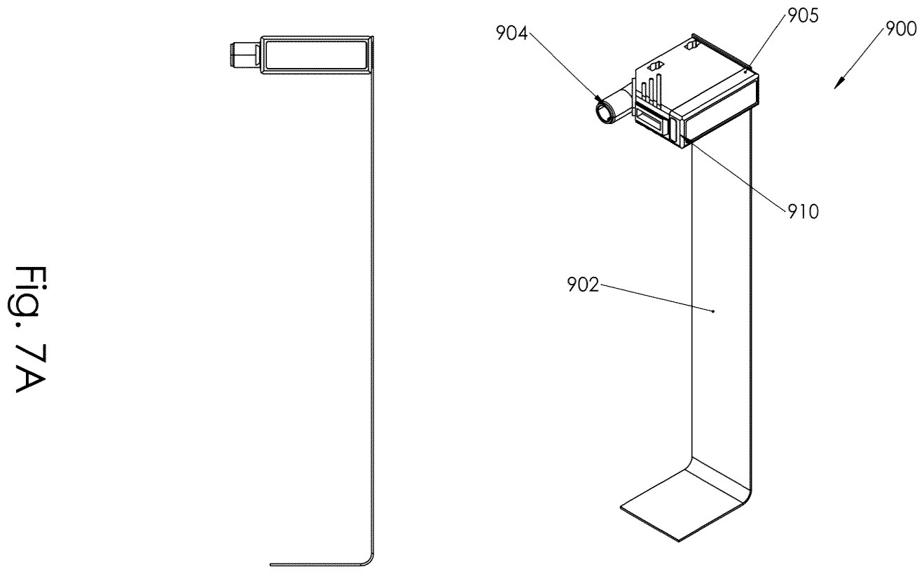

In some embodiments, calibration system 1000 may further comprise a sensing unit 900 (FIG. 7A) configured to determine pipette location relative to the end of the robotic arm 200. Controller 700 uses said pipette location to determine the initial positioning and vertical movement that robotic arm 200 must perform when pushing the pipette into its corresponding tip. Sensing unit 900 may further be configured to similarly determine the tip end location relative to the robotic arm 200. Controller 700 uses this location of the tip end to determine the initial positioning and movement that robotic arm 200 must perform when inserting the pipette tip into the water dispenser 500 to aspirate water into its tip. Accurate positioning is essential to comply with the calibration standards dictating insertion depth and aspiration procedure. Sensing unit 900 may be a laser photoelectric sensor apparatus though other sensors may be implemented.

In some embodiments, calibration system 1000 may further comprise a water container or water reservoir 1100, which provides purified clear water to water dispenser 500, e.g., via tubes and pumps. The clear water reservoir 1100 may be held beneath the system, and not as illustrated in FIG. 1. Two pipes may be connected to clear water reservoir 1100; one pipe may be configured to pump water into the water dispenser 500 and the other pipe may be configured to receive returning water from water dispenser 500, e.g., clear overflowed water, as will be further explained with respect to FIG. 6.

In some embodiments, water dispenser 500 may be similar to a sink with two exits and one inlet. The inlet may enable water to enter directly from the clear water reservoir 1100 by an electric pump. Water from the two outlets is configured to go back into the clear water reservoir 1100.

One of the two outlets may be located on a sidewall of water dispenser 500, similarly to any sink. This sidewall outlet may keep the water level of water dispenser 500 constant, since after each time of water extraction from water dispenser 500, the water dispenser 500 will be refilled and excess water will go from the sidewall pipe to clear water reservoir 1100. In this embodiment, water will not spill through the sides of water dispenser 500 but will rather only pass through the sidewall outlet to the tube to the clear water reservoir 1100.

The second outlet may be similar to the bottom outlet of a sink. The second outlet at the bottom of water dispenser 500 will normally be closed (similarly to a stopper). This outlet may only be opened during maintenance, e.g., during weekends, to enable calibration system 1000 to dry.

As explained hereinabove, the calibration system 1000 must monitor the water level. In some embodiments, the calibration system 1000 may measure the water level using sensor(s). In some embodiments, the structure and operation of the water dispenser 500 may maintain a constant water level, as will be explained hereinbelow with respect to FIG. 6, in which case there is no need to measure water level but rather water level maintains substantially constant. In some embodiments, water container 1100 may be a water container, a connection to a purifying station, or any other purified water source.

In some embodiments, calibration system 1000 may comprise one or more of: robotic arm camera 1700A, i.e., a camera embedded in or attached to the robotic arm itself; gripper camera 1700B, i.e., a camera attached to the robotic arm gripper; top camera 1700C; and side camera 1700D. Each of these cameras may either be a regular digital camera or any similar imaging device capable of obtaining similar results as that of a digital camera; whereby the results required by the cameras are described hereinafter. The term “camera”, e.g., camera 1700 may sometimes refer to any subset of those four optional cameras, as those are partly interchangeable in their function. It is further emphasized that different combinations are possible and may be equivalent in different implementations; for example, (a) gripper camera 1700B only, (b) top camera 1700C only, (c) top camera 1700C and side camera 1700D, and so on, in any combination thereof. All four possible cameras 1700 appear in FIG. 1 for illustration purposes only.

In some embodiments, a mechanical probe may either replace gripper camera 1700B, or it may be added to gripper camera 1700B. Such mechanical probe may be mounted on electro-mechanical gripper 202 and may be configured to map the location of each tip within a tip cartridge.

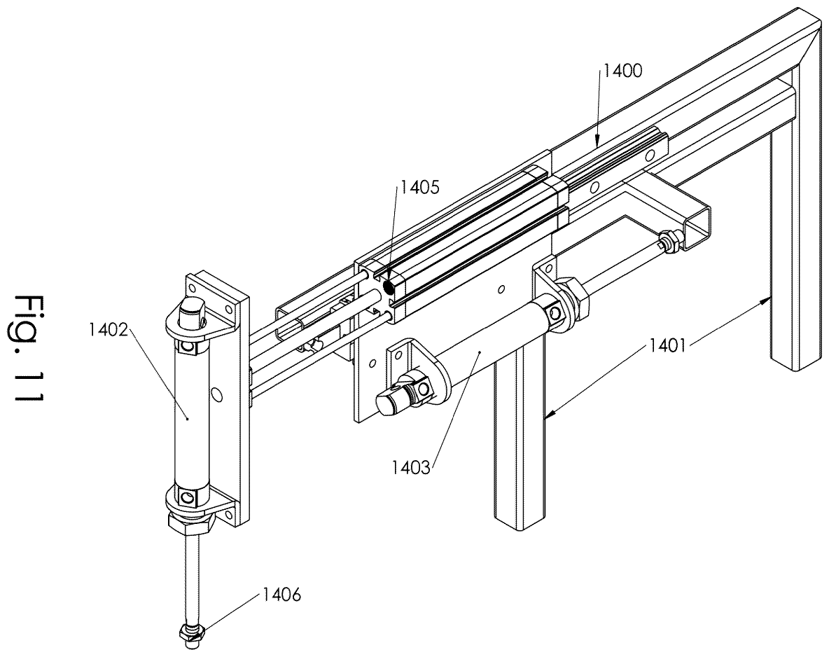

In some embodiments, calibration system 1000 may comprise environmental condition sensor(s) 1500 and water quality sensor(s) 1600, schematically illustrated in FIG. 1. Environmental condition sensor(s) 1500 may comprise, for example, temperature, humidity, and barometric pressure sensors. Environmental condition sensor(s) 1500 may be located as illustrated in FIG. 1, or may be located adjacent to weighing area, e.g., adjacent scales 600, and remotely of any heat sources in calibration system 1000. Water quality sensor(s) 1600 may comprise water temperature and water conductivity sensors located inside water dispenser 500, while quality sensors 1600 may be located as illustrated in FIG. 1. Following the instructions in the relevant standard (e.g., ISO 8655-6:2022), controller 700 (FIG. 2) uses the measured temperatures, humidity, air pressure, and water conductivity to correct the results as designated in any relevant standard and set off an alarm if one or more of those deviates from accepted conditions and tolerances. In some embodiments, calibration system 1000 may comprise drainage system 1400 (FIG. 11). In some embodiments, calibration system 1000 may comprise a bin 1200 for keeping the used tips and empty tip cartridges, which may or may not be recycled.

Pipette calibration according to the current ISO 8655-6 standard requires a specific calibration procedure that includes a functional measurement-based examination of each pipette. This procedure includes measuring at least 3 different predefined volumes for an adjustable pipette, whereby at least 10 separate measurements are required per volume, while replacing the pipette's tip once every 5 measurements. The measurements must be performed by aspirating water into the pipette tip from water dispenser 500 and then extracting the predefined measured water volume into another container, e.g., a beaker. That container resides on an accurate analytic scale system 600. The scale system connects to a computer or controller 700, which analyzes the difference in water weight added through the scale measurement and by taking into consideration the environmental parameters to calculate the volume of water transferred from the pipette.

Each pipette has its unique identification number and a specific calibration procedure defined specifically per that pipette, with respect to predefined calibration volumes, repetitions, tip type, customer details, etc. Typically, a lab performing such calibration has these parameters predefined in its ERP (Enterprise Resource Planning) system. Accordingly, the semi-automatic calibration system 1000 of the present disclosure may be configured to receive such data, calibrate, and report the results per each pipette. Identification of each pipette with a location at the pipette holder 100 may be done by manual typing, scanning a barcode, a QR code, an RFID tag, or by any other similar means.

In some embodiments, different known error-prevention methods may be used to reduce typing mistakes. Such methods are relevant when using manual typing for identification per location. Such methods may include adding a check digit at the end of the pipette identification number, an independent double-checking process, verifying the identification number refers to a relevant pipette, and other similar methods.

The semi-automatic calibration system 1000 of the present disclosure is configured to perform a round of measurement cycles or measurement batches for a group of pipettes, e.g., 50 pipettes, one following the other, without human intervention. Such a measurement round of 50 pipettes and 10 measurements per each, should take approximately 2 hours. At the end of such measurements' round (i.e., 10 measurements per pipette, per each predefined calibration volume), the system is stopped or goes into a standby state. Consequently, a human operator manually changes the predefined calibration volume per pipette in the group to another predefined calibration volume, following the procedure designated for that particular pipette. Manual calibration volume change of the entire group of pipettes should take approximately 3 to 10 minutes. The calibration volume change is preferably performed manually and not automatically by calibration system 1000. Learning and handling different adjustment mechanisms is a relatively easy task for a human. By contrast, automatic adjustment of calibration volume would entail extreme complications added to the calibration system 1000. Automatic adjustment is complex since each type of pipette has a slightly different adjustment mechanism. A general automatic volume adjustment mechanism would need the mechanical capability to handle any adjustment mechanism and be programmed to handle every possible variation. Such a complex automatic volume adjustment mechanism would further dramatically increase the costs of calibration system 1000, making it less accessible.

An advantage of the present system is that calibration volume adjustment is performed manually for an entire group of pipettes, one after the other, by an operator and at the same calibration stage. That is, instead of calibration volume adjustment done per each pipette before the aspiration process, which is more time-consuming and error-prone, the calibration volume adjustment is manually done for an entire group of pipettes at the same calibration stage. A complete measurement round of calibration system 1000 is then performed continuously. A batch of measurements is performed on each of the group's pipettes, one after the other. To comply with ISO 8655-6:2022, following the first round comes another session of manual volume adjustment, a second continuous round of pipette calibration, a third round of manual volume adjustment, and a third continuous round of calibration. Other applicable standards as well as possible special calibration requirements may require adjustments of this procedure. This unique combination of manual and automatic operations is the key to maintaining the calibration procedure significantly shorter than a complete manual calibration process. On the other hand, it is easier to implement, less complicated, and thus less expensive than fully automatic calibration systems complying with international standards (which are yet to be fully developed and implemented).

In some embodiments, pipettes with special calibration requirements that suggest additional measurement volumes, may be tested and calibrated in a similar manner with any number of rounds, as needed.

Prior to the first round of measurements per the first calibration volume, each pipette is assigned a cell number of a tip storage compartment 300, from which corresponding tips are to be taken and used, and the pipette identification and match to a location on the pipette holder process takes place. This preparation process may take several minutes, typically 30 minutes. Following the third round of measurements, the operator orderly removes the pipettes from the pipette holder and manually signs a calibration report per each pipette. This concluding process may take several minutes, typically 30 minutes. Thus, the semi-automatic system of the present disclosure can calibrate approximately 50 pipettes in roughly 9 hours of operation—about 30 minutes of initial preparation, 3 rounds of approximately 2 hours, about 2 hours of manual adjustments, handling malfunctions that might occur, and time the calibration system 1000 may wait for operator 1020, and about 30 minutes at closing. Accordingly, estimating 240 single-shift working days per year and assuming 10% of the pipettes are found inaccurate and require adjustment and re-calibration, approximately 11,000 pipettes may be calibrated per year, by calibration system 1000, following the strict ISO calibration standard available. Such a calibration system may decrease the current working time by about 80-90% for a single-shift working day.

Reference is now made to FIG. 2, which is a schematic illustration of a system of calibration of a plurality of pipettes encapsulated behind a closed container, according to embodiments of the disclosure. In some embodiments, calibration system 1000 may be encapsulated or positioned within a closed container, preferably a transparent encapsulation container 1010. An operator 1020, e.g., an employee assisting in operating calibration system 1000, may open encapsulation container 1010 to reach the different units of calibration system 1000. For example, operator 1020 may open operator door 1030 of encapsulation container 1010 to reach pipette holder 100 and manually adjust the calibration volume of each pipette on the pipette holder 100 according to a predefined volume. The predefined calibration volume per each of the three measurement rounds depend on the type of pipette, e.g., the pipette size, its volume resolution, and, in some cases, per customer request.

In some embodiments, calibration system 1000 may comprise a user interface 800, which may comprise a display unit, and which may be in direct communication with controller 700. User interface 800 may display information related to the calibration procedure, for example, notifications concerning the calibration steps or any malfunction of any of the units of calibration system 1000. In some embodiments, the notifications may comprise any combination of the following: notification of the end of calibration of the group of pipettes, malfunction of the calibration process, the water level in the water container 1100 being below a predetermined threshold, environmental conditions such as temperature, humidity, or pressure are above or below a predetermined threshold, the robotic arm is not able to grip a pipette, tip not found after attachment to a pipette, pipette holder is not moving, water emptying system malfunction, water purity does not meet predetermined conditions, missing tip per pipette in the tip storage compartment, operator door is open, end of batch and operator is required to adjust a new predefined calibration volume, end of the final round, report signature is missing, and similar notifications.

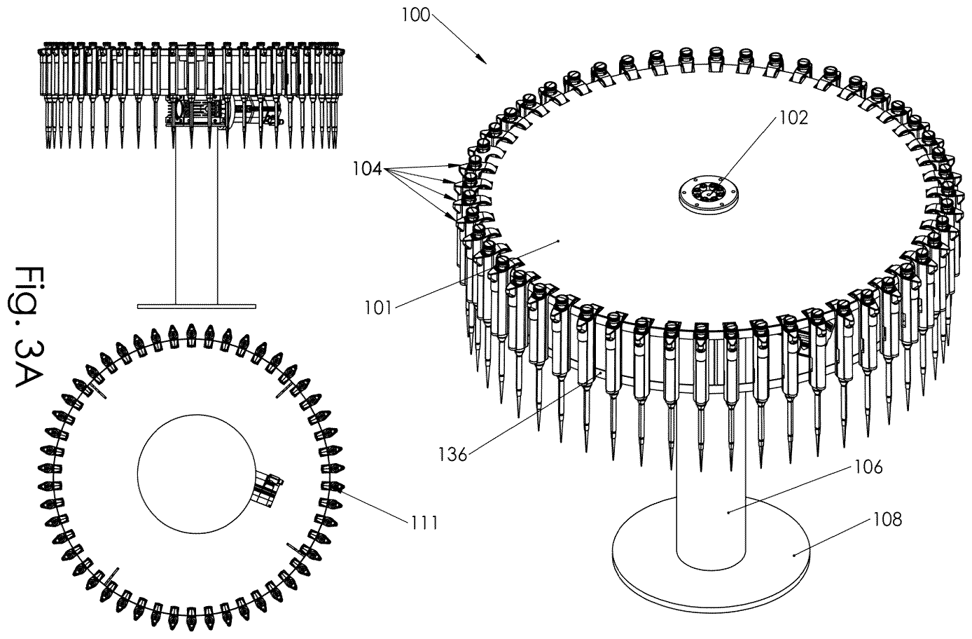

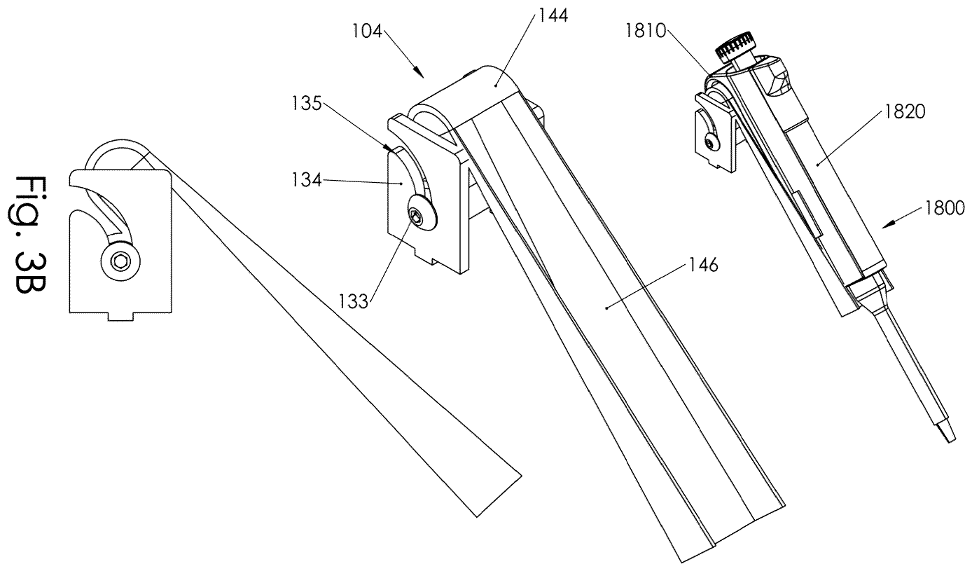

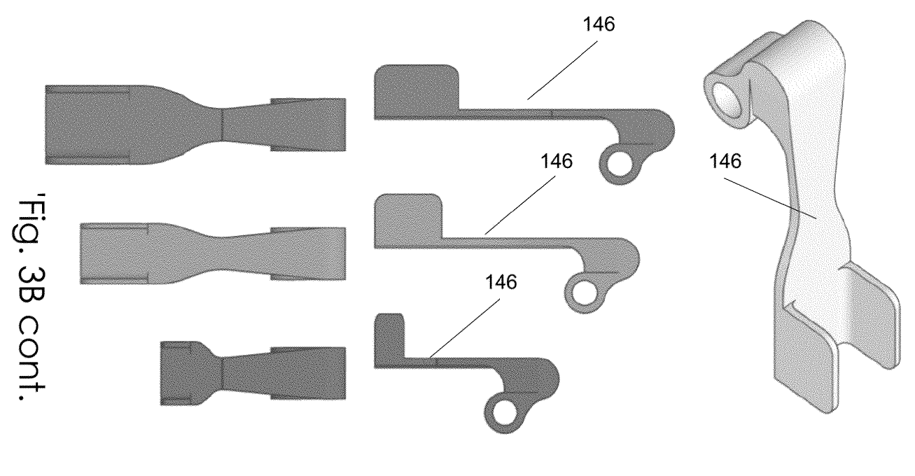

Reference is now made to FIG. 3A, which is a schematic illustration of a pipette holder according to embodiments of the disclosure. Pipette holder 100 may be a carousel, which may pivot around a central pole 106. Other reasonable options are a static matrix formation (soldiers march formation, which includes several rows of pipettes, with enough clearance for the gripper) or a linear column of hangers moving over a rail with linear guides and actuators, and so on. For example, pipette holder 100, which may comprise a group of pipette hangers 104 connected to a pipette holder surface 101, may pivot around pipette holder pole 106 over a base 108. The pipette holder rotates on pole 106 by motor 102, e.g., a servomotor, a step motor, or any equivalent. The lower parts of pipette hangers 104 (e.g., parts 146, FIG. 3B) may rest on perimetric ring 136 to stabilize them from swinging. Controller 700 controls the rotation of pipette holder 100 so that a specific pipette that the robotic arm 200 is to extract from the pipette holder 100 and that the robotic arm 200 is to return to pipette holder 100 would be positioned at a designated location 111 each time and for any pipette. That is, instead of maneuvering the robotic arm 200 around pipette holder 100, it is the pipette holder 100 that rotates toward the robotic arm 200 so that robotic arm 200 would repeatedly get to designated location 111 from which to reach out to a new pipette from the pipette holder 100. This rotation controlled by controller 700, reduces the size (e.g. length) of the required robotic arm 200 as it does not need to reach all sides of the pipette holder 100. It also simplifies the control of the robotic arm 200 and minimizes maneuvering time.

In some embodiments, motor 102 must alternately enable manual rotation of pipette holder 100 by the human operator and be controlled by the computerized controller 700. In some embodiments, the computerized controller 700 governs motor 102 only if operator door 1030 is closed. A switching mechanism allows manual rotation of pipette holder 100 by the human operator when operator door 1030 is open. In some embodiments, this alternation may require motor 102 to have a clutch system. In some embodiments, this alternation may require motor 102 to have a rotary position sensor to determine the angle of the pipette holder 100 after manual rotation or during motorized rotation.

In some embodiments, the robotic arm 200 may be configured to rotate the pipette holder 100. In such case, the pipette holder 100 does not need an independent motor. However, a spring ball plunger, an electromagnet, or similar means may restrict its free rotation. Robotic arm 200 may use erected rigid rods or similar means to hold and spin pipette holder 100.

The operator may manually rotate the pipette holder 100 while loading, removing, adjusting calibration volume of the pipettes, or caring for any fault operation.

In some embodiments, pipette holder 100 may comprise a group of pipette hangers 104, e.g., approximately 50 pipettes, though different numbers of pipette hangers 104 are also possible.

Reference is now made to FIG. 3B, which is a schematic illustration of a pipette hanger attached to the pipette holder, according to embodiments of the disclosure. Pipette holder 100 may comprise a plurality of pipette hangers 104, which may be similar to one another and may enable attachment of different types of pipettes with respect to size, shape, and/or operating mechanism. Pipette hanger 104 may comprise a pipette hanging element 144, an elongated member 146, and an interface 133. Changing the exact shape of pipette hanger 104 to fit different pipettes is possible by redesigning hanging element 144 and elongated member 146 for a specific pipette type, e.g., elongated member 146 may be shorter or longer per pipette type, as illustrated in FIG. 3B′, though other changes may be implemented. However, interface 133 between pipette hanger 104 and static connector 134 should be effectively identical. This interface standardization makes pipette holder 100 a modular universal pipette hanger that substantially any pipette type may fit onto.

In some embodiments, the interface 133 between pipette hanger 104 and static connector 134 may allow quick exchange between hangers compatible with different pipettes. In some embodiments, static connector 134 may comprise a rail 135 on each of its opposite sides to implement that quick exchange. The rail 135, which interface 133 is able to move along, allows fast assembly and disassembly of interface 133 of pipette hanger 104, hence quickly exchanging a pipette hanger 104 with another. This immediate exchange between hangers compatible with different pipettes makes the pipette hanger 100 more modular.

In some embodiments, a hinge may allow changing the vertical angle between the elongated member 146 and pipette holder pole 106. Such change may allow raising elongated member 146 when specific pipette hanger 104 reaches the designated location 111 (FIG. 3A). As the elongated member 146 extends or is raised, it is easier for robotic arm 200 to pick up and replace the pipette 1800. In some embodiments, interface 133 may comprise a bolt and nut, pin, or any other suitable hinge structure known in the art to create said hinge.

In some embodiments, the size and shape of elongated member 146 and of pipette hanging element 144 enable placing substantially any shape and size of pipette onto pipette hanger 104. In some embodiments, manufacturers configure rounded hook 1810 of any pipette 1800 to hang optimally onto pipette hanging element 144 and body 1820 of any pipette 1800 to rest optimally on elongated member 146. Implementing such design standardization may further reduce calibration costs, as there would be no need for multiple types of pipette hangers 104, but rather the design of pipette hanger 104 provided in FIG. 3B is suitable for typically any size and shape of pipette.

Reference is now made to FIG. 3C, which is a schematic illustration of a subsystem extending a pipette toward the robotic arm. There are many options to implement such subsystem, for example, a fixed protruding arm located beneath the surface of pipette holder 100, configured for raising an elongated member 146 as it is pushed against said arm while pipette holder 100 is spinning; placing miniature linear actuators behind the upper part of each elongated member 146 that pushes elongated member 146 forward when needed; placing one linear actuator between pipette holder pole 106 and the extension position, e.g., designated location 111. In some embodiments, a linear actuator 112 is located beneath pipette holder surface 101, between pipette holder pole 106 and designated location 111. Once the relevant pipette hanger 104, while pivoting with pipette holder 100, faces designated location 111, the linear actuator 112 pushes elongated member 146 to raise it, and push it away from perimetric ring 136. Back-pushing elongated member 146 extends it away from adjacent pipettes and holders to provide enough space and a convenient gripping angle for robotic arm 200. As gravitation is now adjoining pipette 1800 and elongated member 146, the extension also provides better fixation of the pipette 1800 on the elongated member 146 to optimize pipette gripping by the robotic arm 200. After placing pipette 1800 back on pipette hanger 104, the linear actuator 112 retreats, and elongated member 146 resumes its non-raised position.

Reference is now made to FIG. 4, which is a schematic illustration of a tip storage compartment, according to embodiments of the disclosure. Tip storage compartment 300 may comprise a plurality of cells, which may be of different sizes, e.g., cells 302, 304, and 306. Different cell sizes conform to different sizes of tip cartridges stored within tip storage compartment 300. In some embodiments, some or all cells can store more than one tip cartridge arranged in a row, one tip cartridge after another, till the last tip cartridge reaches the opening of the cell. In some embodiments, tip storage compartment 300 may be arranged in an arched shape, such that distance of the base of robotic arm 200 from each cell of tip storage compartment 300 is substantially similar, thereby minimizing the size of the needed robotic arm 200.

In some embodiments, the bottom side of each of the cells of tip storage compartment 300 may be positioned at an angle with respect to the floor of calibration system 1000, e.g., at an angle α. Angle α may be smaller than 90 degrees, e.g., between 10-15 degrees, where the front side of the cell facing the robotic arm 200 is lower than the rear side. Angle α enables the tip cartridge in a cell to slide toward the frontal cell opening 309. Approaching the frontal cell opening 309 enables robotic arm 200 to easily reach the tip cartridge, extract it from the cell, place it at the tip cartridge bay 400 (FIG. 5), and later return it to the cell. Once a tip cartridge is removed from its cell by robotic arm 200, the tip cartridge positioned behind the one removed slide toward the frontal cell opening 309 to replace the extracted cartridge.

In some embodiments, to allow sliding of the tip cartridge towards the cell opening but yet to prevent the tip cartridge from freely falling outside its cell, each cell comprises a stopper 310 at the cell opening. Stopper 310 may be a raised extension of the bottom side of the cell, preventing the tip cartridge from slipping out of the cell. Removing a tip cartridge out of the cell thus requires a slight lift of the gripped tip cartridge to raise it above stopper 310 before pulling the tip cartridge out of its cell.

In some embodiments, to enable the smooth sliding of a tip cartridge along the cell, each cell may comprise smooth rails 322 on the opposite sides of its bottom. The tip cartridge within the cell may slide on top of rails 322 until stopped by stopper 310.

In some embodiments, when a tip cartridge is to be returned to the tip storage compartment 300 by robotic arm 200, the returned tip cartridge would be required to push the tip cartridge currently positioned at the frontal cell opening, 309 i.e., the one tip cartridge previously set behind it, towards the back of the cell. The robotic arm 200 must also finish pushing the returned tip cartridge by slightly lowering it just behind the stopper 310. The returned tip cartridge is now positioned (again) at the frontal opening 309 of the cell.

In some embodiments, a cell may comprise a slopped floor 312 holding smooth rails 322 and stopper 310, two side walls 311, and an optional roof. The roof is typically the floor of another cell located above. In some embodiments, the slopped floor 312 attaches to the side wall 311 using fastener 308, which may be a bolt and nut or other type of fastener. Typically, fastener 308 is located below the top end of each of the adjacent smooth rails 322. This location of fastener 308 is designated to prevent contact between the tip cartridge and fastener 308, thereby ensuring smooth sliding of the tip cartridge along smooth rails 322.

In some embodiments, calibration system 1000 would notify the operator, or the operator would be required to determine independently, whether a cell is empty of tip cartridges and needs to be refilled with the corresponding tip cartridges (without their covers, such to be ready for use).

In some embodiments, there may be a software for controlling operation of calibration system 1000. The software may suggest to the operator which type(s) of tips to use per pipette model, e.g., via user interface 800. The operator thereby controls selecting the appropriate cell of tip storage compartment 300, from which to take a corresponding tip cartridge.

Reference is now made to FIG. 5, which is a schematic illustration of a tip cartridge bay according to embodiments of the disclosure. In some embodiments, calibration system 1000 may comprise tip cartridge bay 400. Calibration system 1000 may use robotic arm 200 to extract tip cartridge 1900 from tip storage compartment 300 and fixate it in tip cartridge bay 400. Following the placement of tip cartridge 1900 at tip cartridge bay 400, robotic arm 200 releases its contact with tip cartridge 1900. Tip cartridge 1900 is then fixated by the moveable arms in tip cartridge bay 400, as explained below. Fixation of the tip cartridge 1900 enables convenient extraction of tips from tip cartridge 1900 while attaching them to the distal end of the pipette. In some embodiments, the fixation may be done even before robotic arm 200 releases its contact from tip cartridge 1900. When returning tip cartridge 1900 to the tip storage compartment 300 or carrying it into bin 1200 in case tip cartridge 1900 is empty, the robotic arm 200 attaches itself to tip cartridge 1900, and the fixation of tip cartridge 1900 by tip cartridge bay 400 is released.

In some embodiments, tip cartridge bay 400 may comprise a flat base 402 and two raised sections 404 and 406, located perpendicular to one another, to create a corner. Tip cartridge bay 400 may further comprise two jaws or extendable arms 412 and 422 configured to push and fixate tip cartridge 1900 against the corner created by the raised sections 404 and 406. The two jaws, 412 and 422, are positioned perpendicularly, closing on one rectangle with raised sections 404 and 406. Raised section 404 is parallel to Jaw 422. Raised section 406 is parallel to Jaw 412. Each of jaws or extendable arms 412 and 422 is positioned within a corresponding housing 410 and 420, respectively. A linear actuator extracts each jaw from its housing once the robotic arm 200 places tip cartridge 1900 onto flat base 402. In some embodiments, controller 700 uses camera 1700 (FIG. 1) to determine whether tip cartridge 1900 is positioned correctly within tip cartridge bay 400 on top of flat base 402. Such determination may indicate to jaws 412 and 422 to extend out of their housings.

In some embodiments, calibration system 1000 operation requires locating/identifying and counting tips within tip cartridge 1900 following the fixation. Locating at least one tip is necessary to connect a tip to pipette 1800 as part of the calibration process. In some embodiments, calibration system 1000 identifies a ‘final tip’ scenario to control robotic arm 200 to dispense the empty tip cartridge into bin 1200 instead of returning it to tip storage compartment 300. To continue the ‘final tip’ scenario, calibration system 1000 extracts a new similar or different tip cartridge from tip storage compartment 300. If a tip cartridge is unavailable at the tip storage compartment 300, calibration system 1000 notifies the operator. In some embodiments, calibration system 1000 identifies the 3D location of a tip before attaching it to the pipette. An imaging device may locate the 2D horizontal location of a tip. The imaging device may be robotic arm camera 1700A, gripper camera 1700B, or top camera 1700C positioned above the fixated tip cartridge in tip cartridge bay 400. Identifying tip height may be performed via several methods. One method may be using robotic arm camera 1700A or gripper camera 1700B positioned more or less horizontally, or side camera 1700D. In this method, the camera identifies the tip height by imaging the tips from their side. A second method may be triangulation, which requires the known 3D location of two imaging devices. One device must be a camera or a similar device; the other device may be another camera (Stereoscopic Imaging) or an illumination source that would generally be coded or otherwise distinguished (usually referred to as Structured Light). For this second method, robotic arm camera 1700A, gripper camera 1700B, or top camera 1700C may be equipped as 3D imaging devices, using at least two in conjunction or at least one of the cameras with an external illumination source. Another triangulation option is for robotic arm camera 1700A or gripper camera 1700B to take two or more 2D images from significantly different angles by moving robotic arm 200 between different locations. A third method may be using external data stored in some external database, like an ERP system, or data manually inputted by the operator. To enable automatic operation, such external data per cell in the tip storage compartment 300 must be available to the calibration system 1000 before starting the calibration stage. A fourth method may comprise controlling robotic arm 200 in a slowly descending movement towards a specific tip within the tip cartridge until robotic arm 200 senses resistance from the now connected tip. The distance made by robotic arm 200 for this particular tip connection may then be recorded and repeated more rapidly per each tip connection of a tip from the same tip cartridge. Reference is now made to FIG. 6, which is a schematic illustration of a water dispenser according to embodiments of the disclosure. In some embodiments, calibration system 1000 may comprise a water dispenser 500 from which the pipette may aspirate water into its connected tip at the predefined calibration volume. Each measurement of each round or batch of calibration requires such aspiration. For example, calibration standard ISO 8655-6:2022 allows immersion of the tip in the aspirated water in a small subrange running between 1 mm and 6 mm deep, depending on the pipette volume. To comply, calibration system 1000 must accurately position the tip end relative to the water level of water dispenser 500. Appropriate identification of the 3D position of the tip's end is described in relation to FIG. 7 below. To complete the relative positioning, controller 700 must identify the water level of water dispenser 500 and control the aspiration process accordingly. Identifying the water level of water dispenser 500 requires either measurement or stabilization around a fixed water level. In some embodiments, water dispenser 500 may comprise a simple water basin (not shown) and be level-monitored by one of several methods, allowing at least 1 mm resolution and accuracy of real-time water level measurement. Some examples of such methods are water level sensors based on radar, pressure sensors, e.g., capacitive ceramic sensors, ultrasonic liquid level sensors, triangulation of the level of a float using one of the methods described above in relation to FIG. 5, and direct triangulation of the water level by imaging in relevant spectra of the electromagnetic spectrum where water has high absorbance.

In some embodiments, water dispenser 500 may comprise a stabilized water container 502 and a stabilizing water container 504. The stabilized water container 502 may comprise higher edges and thus a higher water level compared to the water level of stabilizing water container 504. Repeatedly refilling stabilized water container 502 maintains a specific water level directly set by the height of the edges of stabilized water container 502. Stabilizing the water level at the stabilized water container 502 of water dispenser 500 takes place before every water aspiration by a pipette from water dispenser 500. The stabilization phase comprises pumping a generous volume of water from stabilizing water container 504 to stabilized water container 502 using an electro-mechanical pump (not shown). Any excessive water pumped into stabilized water container 502, when refilling it, spills into stabilizing water container 504, returning the water level at stabilized water container 502 to the required level, dictated by the height of the edges of stabilized water container 502. In some embodiments, the shapes of both water containers 502 and 504 are circular, and stabilized water container 502 resides within stabilizing water container 504. However, other shapes and settings may be used.

In some embodiments, water container 1100 (FIG. 1) repeatedly refills water dispenser 500 to maintain water level at the height of the edges of stabilized water container 502. This refilling process does not have to maintain an accurate water level at water dispenser 500, since water may spill towards stabilizing water container 504 if too much water is pumped into stabilized water container 502. Therefore, a simple sensor or mechanism may control the refilling process. In some embodiments, an electro-mechanical pump (not shown) pumps water from water container 1100 to water dispenser 500. In some embodiments, water container 1100 is positioned higher than water dispenser 500. A valve (not shown) controls gravitational water flow from water container 1100 to water dispenser 500.

In some embodiments, the ‘refill and spill’ stabilization method described above may be implemented using a single stabilized water container 502 with a water inlet and a water outlet. The water inlet may fill water pumped from water container 1100, whereby the water container 1100 may be positioned below the position of stabilized water container 502, thereby omitting presence of stabilizing water container 504. The water outlet may assist with spilling the water back to the water container 1100 to create the stabilizing water level effect.

In one example, stabilized water container 502 is circular. According to the calibration International standard ISO 8655-6:2022, for the maximal predefined calibration volume (V) of 20 ml, the allowed tip immersion depth is between 3 and 6 mm. The allowed depth leaves an immersion gap (G) of 3 mm (as this is the minimum allowed immersion depth). In case water level drops in more than 3 mm during water aspiration, then the tip is not within the allowed tip immersion depth, which means either water should be pumped into water container 502 to refill it, or that the tip should be further pushed down into water container 502 up to a 6 mm in total of allowed tip immersion depth. The latter may be implemented by measuring both the water level of water container 502 as well as the spatial position of robotic arm 200. Alternately, the water basin diameter should be big enough so that the largest volume pipette (e.g. 20 ml) would not lower the water level by more than a predetermined level as prescribed by the reference standard. A safety tolerance (T) of 0.5 mm for the water level is assumed below and above the tip immersion position to ensure compliance while using a current real-world physical robotic arm. The following formula (I) calculates the minimal diameter (D) for stabilized water container 502 to ensure that water aspiration with a static tip complies with the defined immersion gap and tolerance.

$$D = 2 \times \sqrt{V / ( π ( G - 2 T ) )} . \qquad ( I )$$

Rounding up, the result is a diameter (D) of 113 mm. Calibration standard ISO 8655-6:2022 allows smaller immersion gaps for a more miniature-volume pipette. However, for stabilized water container 502 with a diameter of 113 mm or more, the water level reduction while aspirating with such pipettes is negligible (below 0.1 mm). Therefore, to comply with said restrictions, a pipette of a predefined volume of 20 mL should be positioned to start aspiration at an immersion depth of 5.5 mm. For stabilized water container 502 with a diameter of 113 mm, the pipette tip completes the aspiration at an immersion depth of about 3.5 mm. For the same conditions with a predefined volume of 10 mL, it is reasonable to start aspiration at an immersion depth of 5 mm, which ends at about 4 mm. For pipettes of a predefined volume below 5 mL, it is reasonable to start aspiration in the middle of the allowed tip immersion depth, e.g., at an immersion depth of about 3 mm for the range of 100-1000 μl which is 2-4 mm immersion depth, as the water level reduction is negligible compared to the allowed immersion gap.

In a similar example, the height of stabilized water container 502 is 30 mm, and its diameter is 120 mm. Therefore, the volume of stabilized water container 502 is about 340 mL. The height of stabilizing water container 504 is 30 mm, and its diameter is 200 mm. However, stabilized water container 502 is raised compared to stabilizing water container 504, e.g., at approximately 10-15 mm. Therefore, the maximal volume of stabilizing water container 504 is about 600 mL.

In some embodiments, water dispenser 500 may comprise water wiping element 506, which the robotic arm 200 may move the distal end of the tip against. That movement wipes excess water droplets that may stay on the external side of the tip following water aspiration. Such wiping is necessary to avoid an inaccurate weight measurement of the predefined calibration water volume. Such inaccuracy may happen in case excess water droplets are wiped or dropped on the vessel or on scale system 600 during extraction of the aspirated calibration volume from the pipette and onto scale system 600. Water wiping element 506 may comprise a hole. The tip wipes on the edges of that hole as needed. In some embodiments, the tip may be wiped on any external edge of water wiping element 506.

In some embodiments, water dispenser 500 is designed for easy disassembly and reassembly to allow frequent biofilm cleaning. In some embodiments, water dispenser 500 is designed to be quickly drained and dried to allow daily drying to reduce biofilm creation.

Reference is now made to FIG. 7A, which is a schematic illustration of a single-sided laser photoelectric sensor apparatus according to embodiments of the disclosure. A laser photoelectric sensor comprises a beam-emitting laser source and a beam-detecting photoelectric sensor. The laser beam is usually relatively low-intensity red or IR. The apparatus may be single-sided, where the source and sensor are in the same device, and the sensor senses rays returned from objects. In other embodiments, the apparatus may be double-sided, where the source and sensor are in separate opposing devices, and the sensor typically senses the beam directly coming from the source as long as no object obstructs it. In some embodiments, calibration system 1000 may comprise a sensing unit 910 for determining the pipette distal end orientation and location relative to the gripper 202 before attaching a tip to the pipette distal end. These relative location and orientation dictate the robotic arm 200 movements to properly attach the tip to the distal end of the pipette. A sensing unit 910 is further for determining the tip distal end orientation and location relative to the gripper 202. These relative location and orientation dictate the robotic arm 200 maneuvers to properly conduct all further steps while aspirating and extracting water with the pipette equipped with said tip.

In some embodiments, the sensing unit 910 may be a double-sides imaging device, e.g., two dedicated cameras for stereoscopic imaging-based triangulation or a camera and a light source for structured light source-based triangulation. In some embodiments, the sensing unit 900 may comprise touch sensors. In some embodiments, the sensing unit 900 may comprise beam emitter(s) and photoelectric sensor(s), such as a single-sided laser photoelectric sensor or similar options like a measuring light curtain or beam or a double-sided laser photoelectric sensor. In the single-sided case, sensing unit 900 may comprise column 902 holding detection unit 905, which may comprise a laser beam emitter and a laser beam detector. In some embodiments, the approximated distal end of the pipette before attaching the tip and the approximated distal end of the tip after being attached to the pipette are passed through the laser beam several times to determine the 3D location and orientation of those distal ends.

Reference is now made to FIG. 7B, which is a schematic illustration of parameters used for calculations to determine objects' location and orientation, such as the pipette distal end or the tip distal end, according to embodiments of the disclosure. FIG. 7B schematically explains how determination of objects' location and orientation, such as pipette or tip distal ends, is performed.

In some embodiments, calibration system 1000 determines 3D location and orientation of objects from two matching sets of 2D data. In some embodiments, calibration system 1000 may determine such 2D location and orientation by, for example: (a) passing object 910 through the laser beam in different elevations, e.g., 10 mm vertically apart, henceforth measuring 4 points on the object 910 edges near its distal end—A, B, C, and D, (b) if the 4 points are defining a parallelogram with accuracy under some predetermined tolerance, e.g., 0.01 mm, then the vertical line segment connecting the midpoints of the two horizontal sides of a parallelogram AB and CD merge with midline 911 of object 910, (c) otherwise, each pair of points A-D on the right edges and B-C on the left edges of object 910 are defining lines 912 and 913, respectively; from analytical geometry, it follows that given two points (x₁, y₁) and (x₂, y₂), the formula for the line crossing both points is

$$y = \frac{{y}_{2} - {y}_{1}}{{x}_{2} - {x}_{1}} x + ( {y}_{1} - {x}_{1} \frac{{y}_{2} - {y}_{1}}{{x}_{2} - {x}_{1}} ) ,$$

(d) given lines 912 and 913, their intersection point (not shown) is on midline 911, and point C′ is defined on line 913, with the same distance from the intersection point as point D, (e) the midline 911 is now fully defined by the intersection point and the midpoint between points D and C′, (f) from the midline 911 the angle α is defined and robotic arm 200 orientation is corrected accordingly, (g) robotic arm 200 is now maneuvering the object 910 so that the laser beam is emitted directly from laser beam emitter 904 towards midline 911, and (h) robotic arm 200 now elevates object 910 until the laser beam is detected by detection unit 905 on the object bottom line 914, defining the object distal end point E.

Reference is now made to FIGS. 8A-8C, which are schematic illustrations of a front perspective view, a bottom perspective view, and a side view, respectively, of a robotic arm gripper, according to embodiments of the disclosure. In some embodiments, calibration system 1000 may comprise a robotic arm 200 configured to perform the pivotal operations required for the calibration procedure. Some of the operations to be performed by robotic arm 200 are to extract a pipette from the pipette holder 100, grip the pipette, attach a corresponding tip to the pipette's distal end, and perform volume measuring related operations such as aspirating a predefined calibration water volume into the tip and extracting the aspirated water into a beaker or other container placed onto scale 600.

According to some embodiments, robotic arm 200 may comprise an electro-mechanical gripper 202 connected to robotic arm 200 via connection area 230, which may comprise electronic connections to enable receiving power and conducting communication with controller 700. It may also comprise air pressure piping to feed pneumatic equipment. According to some embodiments, the gripper 202 may comprise a pipette gripper 210 configured to extract a pipette from the pipette holder 100 and hold the pipette to enable further manipulation through the calibration procedure. Pipette gripper 210 may comprise two moveable fingers 212, which may be made of rigid material, such as steel, though using other rigid materials is possible. Each moveable finger 212 may be covered by or may have attached non-rigid edges 214. The non-rigid edges 214 of pipette gripper 210 may be made of natural, synthetic, or silicone rubber, though using other non-rigid and flexible materials is possible. The non-rigid edges 214 are part of pipette gripper 210 that holds a pipette to provide better friction and a tighter grip between the pipette and the moveable fingers 212, with currently prevalent technologies, compared to gripping the pipette with rigid fingers, without damaging the pipette. Many gripping technologies are known in the art, other suitable gripping options are available today, and more will probably become available. Implementing pipette gripper 210 with different gripping technologies is possible as long as the gripper 210 holds firmly onto the pipette without damaging the pipette.

In some embodiments, moveable fingers 212 are contractile, i.e., they come closer to one another, such that non-rigid edges 214 come closer to one another, to thereby grip a pipette in between the two non-rigid edges 214 of moveable fingers 212. In some embodiments, moveable fingers 212 are spreadable, i.e., they move farther away from one another to release the pipette from pipette gripper 210 once measurements round per the pipette ended. Controller 700 may control the operation of robotic arm 200, specifically the operation of pipette gripper 210, such that moveable fingers 212 contracts when a pipette should be extracted from pipette holder 100 and spreads when a pipette returns to the pipette holder.

In some embodiments, gripper 202 may have an attached imaging device, e.g., a camera 1700B. In some embodiments, gripper camera 1700B is positioned above pipette gripper 210, adjacent to pipette handlers 220, actuated for aspirating water into the pipette tip and removing a tip from the pipette distal end, as explained below. Pipette handlers 220 replace the function of a human operator, e.g., operation typically performed by the operator's thumb. Camera 1700B may be used to count the tips, determine the location of tips along the tip cartridge, and identify missing tips in the cartridge.

Robotic arm 200 may have an attached robotic arm gripper 202 comprising pipette handlers 220. Pipette handlers 220 may comprise accurate linear actuator 222 (FIGS. 8A, 8C) and a linear actuator 226 (FIG. 8C). In some embodiments, accurate linear actuator 222 may comprise a force sensor that enables controlling pressing force application of an extendable finger 224 (FIG. 8C) onto the pipette plunger 1830, whereby the pipette is non-electronic. Accurate linear actuator 222 may, by definition, comprise a position sensor (not shown). In some embodiments, accurate linear actuator 222 may operate according to a two-stage force application. Water aspiration of the predefined calibration water volume into the pipette tip may be performed by extendable finger 224 applying force at a first predetermined pushing range, extracting a predetermined air volume from the pipette tip. Once the plunger is released, after immersing the pipette tip distal end in water dispenser 500, it creates a vacuum inside the pipette and its tip in the amount required to suction the specific predefined calibration water volume. The extendable finger 224 may then gradually release the pipette plunger 1830 while the pipette tip is immersed in water dispenser 500 at an immersion depth in accordance with the applicable standard, e.g., ISO 8655.

The water aspiration and pipetting are done at a predefined constant velocity of movement of extendable finger 224, controlled by accurate linear actuator 222, thus eliminating the risk of unsmooth aspiration and pipetting due to water turbulence or suction force in air displacement.

In some embodiments, water extraction from the pipette tip and onto the scale system 600, e.g., into a beaker placed on the scales, may be performed by gradual application of force along the two pushing ranges of the pipette plunger 1830, while the distal end of the pipette tip is in contact with the edges of the beaker on scale system 600, at a predetermined angle, e.g., a 30 degrees angle, as determined by the applicable standard, and robotic arm 200 gradually lifts the pipette, possibly while touching the vessel wall, away from scale system 600. Applying force along the two pushing ranges of the pipette plunger 1830 should ensure extraction of the entirety of the water from the tip onto scale system 600.

In some embodiments, the first range of movement of pipette plunger 1830 is to displace the predefined calibration water volume with air and pour out the water from the pipette tip, while the second range of movement of the pipette plunger 1830 is to push out the water drops that stay at the distal end of the tip as a result of water surface tension. Thus, pushing the two ranges of movement of the pipette plunger is essential to ensure the extraction of the entire predefined calibration water volume.

The proper operation of pipette plunger 1830 is not trivial for humans and requires a valid method for robotic operation. Four different levels of opposing force may be measured with substantial differences while pushing pipette plunger 1830. The first is virtually zero before extendable finger 224 touches pipette plunger 1830. The second is the opposing force necessary to move the plunger in the first range, which typically varies between 0.3N and 15N in different pipettes. The third is the opposing force required to move the plunger in the second range (blow-out feature range), typically 2 to 5 times stronger than the second. The fourth opposing force is at the end of the second range, which is far more substantial than the third.

In some embodiments, calibration system 1000 and controller 700 apply a procedure to auto-calibrate the force applied by accurate linear actuator 222 through extendable finger 224 onto the pipette plunger 1830. For best results, calibration system 1000 applies such auto-calibration procedure every time it extracts a pipette 1800 from the pipette holder 100. The auto-calibration procedure may be applied immediately following the pipette 1800 extraction and before the first measurement after that extraction. In this procedure, the accurate linear actuator 222 slowly advances extendable finger 224 onto the pipette plunger 1830 while measuring the opposing force as it changes and mapping the positions of changes up to the fourth opposing force. Accurate linear actuator 222 then retracts extendable finger 224 before starting the aspiration process. The water aspiration and extraction processes may now run according to said mapping.

In some embodiments, calibration system 1000 and controller 700 control the accurate linear actuator 222 by continuously measuring the opposing force as it changes through the different levels without mapping. As the proper water aspiration and extraction processes require faster operation than needed for accurate measurement of opposing force changes, this method may work properly in some cases and less accurately in others, depending on the implementation and specific pipette type.

In some embodiments, robotic arm 200 attaches a tip to the distal end of a pipette 1800 while gripper 202 holds the pipette in between the non-rigid edges 214 of the two movable fingers 212, and by positioning the distal end of the pipette above the corresponding tip in tip cartridge 1900, pushing pipette 1800 down towards the tip by applying a controlled force along a predetermined distance, optionally turning pipette 1800 while inside the tip, to provide a complete and tight connection between the tip and the distal end of pipette 1800, when applicable, and lifting the pipette away from tip cartridge 1900, with the tip sufficiently connected to the distal end of the pipette.

In some embodiments, pipette handlers 220 may further comprise a tip releasing mechanism. In some embodiments, releasing the tip from the distal end of pipette 1800 is performed by robotic arm 200 maneuvering pipette 1800 to a location above bin 1200 and operating the tip releasing mechanism, which comprises linear actuator 226 and extendable finger 228. Applying pushing force by linear actuator 226 via extendable finger 228 onto tip release button 1840 of pipette 1800, causes release of the tip from the pipette. The force applied by linear actuator 226 may be controlled and predetermined, e.g., per type of pipette.

In other embodiments, instead of linear actuator 226, calibration system 1000 may comprise a stationary knob (not shown) positioned adjacent to and above bin 1200. In this case, robotic arm 200 may maneuver pipette 1800 to a position where tip release button 1840 is just under the stationary knob and the pipette tip is above bin 1200. In some embodiments, an actuator pushes the stationary knob against tip release button 1840 to release the tip into bin 1200. In other embodiments, robotic arm 200 may raise pipette 1800 to push tip release button 1840 against a static stationary knob to release the tip into bin 1200.

Reference is now made to FIG. 9, which is a schematic illustration of a robotic arm gripper holding a tips cartridge, according to embodiments of the disclosure. This schematic illustration of a robotic arm gripper emphasizes the vacuum gripper, according to embodiments of the disclosure. In some embodiments, gripper 202 may comprise suction cup grippers or vacuum gripper 240. Vacuum gripper 240 creates a solid grip between gripper 202 and tip cartridge 1900 to enable safe maneuvering of tip cartridge 1900 from tip storage compartment 300 to tip cartridge bay 400 and from tip cartridge bay 400 to either tip storage compartment 300, in case tip cartridge 1900 still contains enough tips, or to bin 1200 in case the tip cartridge is empty or close to empty.

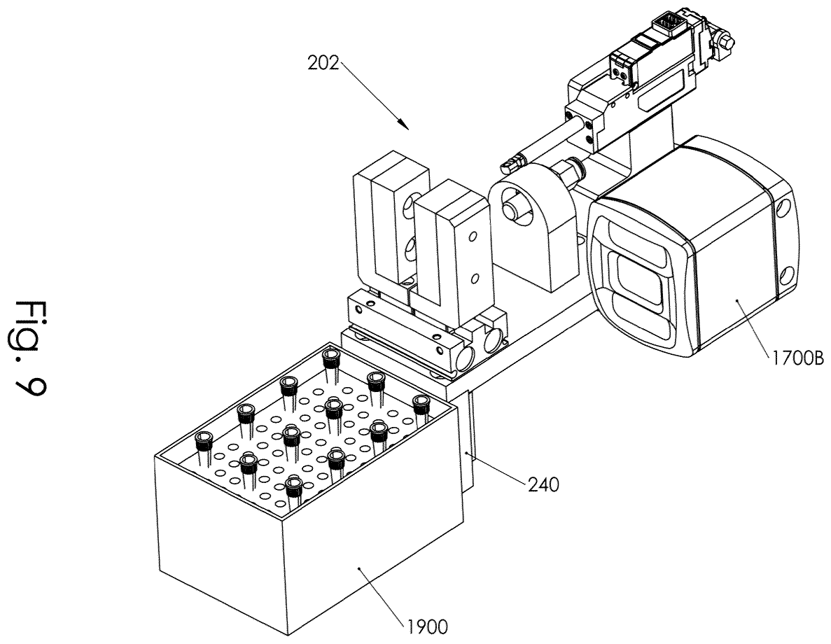

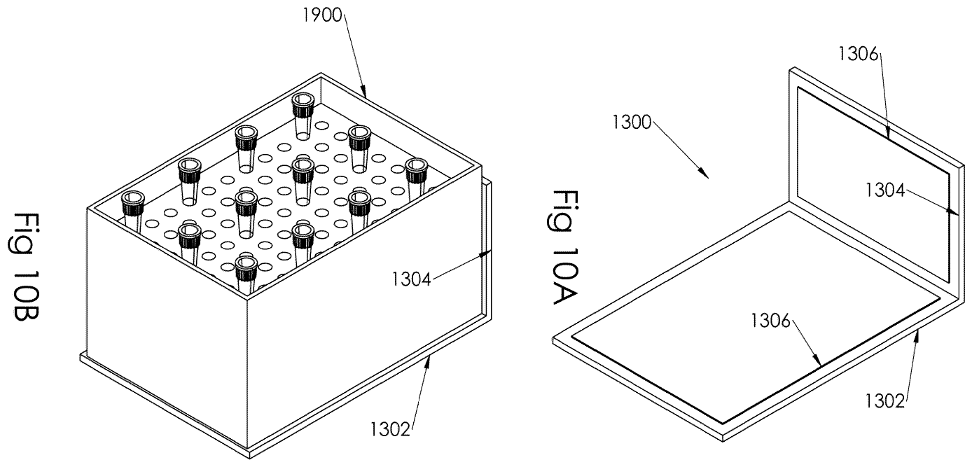

Reference is now made to FIGS. 10A-10B, which are schematic illustrations of a tray before and after it is connected to a tip cartridge. According to embodiments of the disclosure, since not all tip cartridges are similar and do not share the same shape, texture, and material, an optional tray 1300 is provided. Tray 1300 may be needed when the material, shape, or texture of the side of tip cartridge 1900 may not allow effective gripping by vacuum gripper 240. Tray 1300 may also be needed when the material, shape, or texture of the bottom face of tip cartridge 1900 may create excessive friction against smooth rails 322 of tip storage compartment 300. Tray 1300 may be attached to the side and bottom faces of any tip cartridge, e.g., tip cartridge 1900, to provide thereby uniformity of the tip cartridge 1900 interface with vacuum gripper 240 and smooth rails 322 to allow using virtually any relevant tip cartridge prevalent at the market at this time. Tray 1300 allows virtually any tip cartridge to be easily extracted from and placed into tip storage compartment 300 cells via the same attachment method, e.g., vacuum grippers 240. Tray 1300 also allows smooth sliding of tip cartridge 1900 on smooth rails 322 of tip storage compartment 300.

In some embodiments, tray 1300 may comprise a horizontal sheet 1302 and vertical sheet 1304, connected perpendicularly to create an L-shaped tray, similar to a sheet-metal bookend. Tray 1300 may be produced by plastic injection molding, though other methods and materials may also be possible. Connecting means such as adhesive surface 1306 should be present on the inner side of at least one of horizontal sheet 1302 and vertical sheet 1304 to enable connection between tray 1300 to tip cartridge 1900. Adhesive surface 1306 may be applied using simple double-sided adhesive sheets, though other options may also be possible. It appears that applying adhesive surface 1306 on vertical sheet 1304 only should obtain the most effective results in most cases. In some embodiments, at least the outer face of the vertical sheet 1304 and the outer face of horizontal sheet 1302 are flat, such to enable both easy vacuum grip of vertical sheet 1304 by vacuum gripper 240, as well as enable smooth sliding of tip cartridge 1900 having attached the tray 1300, along the smooth rails 322 of each cell of tip storage compartment 300, via the flat outer face of horizontal sheet 1302.

Reference is now made to FIG. 11, which is a schematic illustration of a water drainage system for draining water from the scales 600, according to embodiments of the disclosure. Water drainage system 1400 may be configured to ensure that the one or more beakers 610 (FIG. 1) positioned on scale system 600 are not overfilled with water by the continuous water extraction into those beakers for the calibration procedure. In manual calibration, the calibration technician manually empties excess water from a beaker once required. Some embodiments require an automatic drainage system as it is reasonably possible that a beaker would overfill through one measurement round (e.g., 500 measurements). In some embodiments, a pipette that may contain large liquid volumes (not shown) may be positioned at all times on a designated hanger in calibration system 1000, and robotic arm 200 may use it to aspirate water from the beaker once determined by the software controlling operation of calibration system 1000, e.g., via indication from scale 600 per measured total water weight. Robotic arm 200 may then extract the water into a drainage container or pipe and return the large-volume pipette to its original position. In other embodiments, calibration system 1000 inserts a pump suction nozzle into a beaker 610 positioned on scale 600 to aspirate excess of water once determined by the software controlling operation of calibration system 1000, e.g., via indication from scale 600 per measured total water weight. However, whether fixed in the beaker or placed above the scale 600 through a measurement procedure, such a pump suction nozzle may affect the measurement accuracy, e.g., by releasing a drop of water into the beaker or onto the scale, which would interfere with accurate water weight measuring. To avoid that possibility, part of such drainage system 1400 may be a manipulator that would, when water weight and thus water level is above a predetermined threshold, in between weight measurements, extend the pump suction nozzle to a designated location, allow pumping and draining of excess water, and then retreat to avoid interference with the measurement process. There are several options to implement such a manipulator; SCARA, linear robot, horizontal linear actuator and vertical linear actuator, and horizontal rotary joint actuator and vertical linear actuator are a few examples.

In other embodiments, a retractable hose (not shown) equipped with a pump (not shown) may be positioned at all times on a designated hanger in calibration system 1000. One end of this hose may be connected to a suction pump and drainage container or pipe, and a suction nozzle may be connected to the other end. When water weight and thus water level is above a predetermined threshold, in between weight measurements, robotic arm 200 may hold and extend the suction nozzle to a designated location, allow pumping and draining of excess water, and then retreat the suction nozzle to its original position to avoid interference with the measurement process. There are several options to implement such retractable hose, for example, a spring equipped reel or coiled (spiral) hose.

In some embodiments, drainage system 1400 may comprise at least one support pillar 1401, which supports drainage system 1400, two linear actuators, and a linear guide. Vertical linear actuator 1402 enables movements of the pump suction nozzle 1406 along the vertical axis, horizontal linear actuator 1403 enables movements of the pump suction nozzle along the horizontal axis, and linear guide 1405 supports and regulates movements along the horizontal axis. The two linear actuators, 1402 and 1403, move the pump suction nozzle to its proper location above either one of the scales of scale system 600 to drain water therefrom. Drainage system 1400 must also include (not shown) a pump, tubes, suction nozzle, and drainage container or piping system, enabling water from scale system 600 to flow therethrough. When not in use, drainage system 1400 should be positioned far enough from scale system 600 to prevent interference by water dripping. Drainage system 1400 should also include some mechanism to collect water drops.

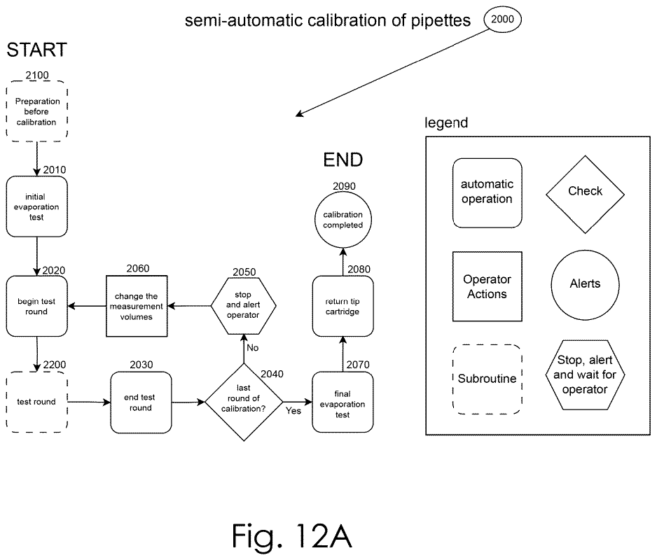

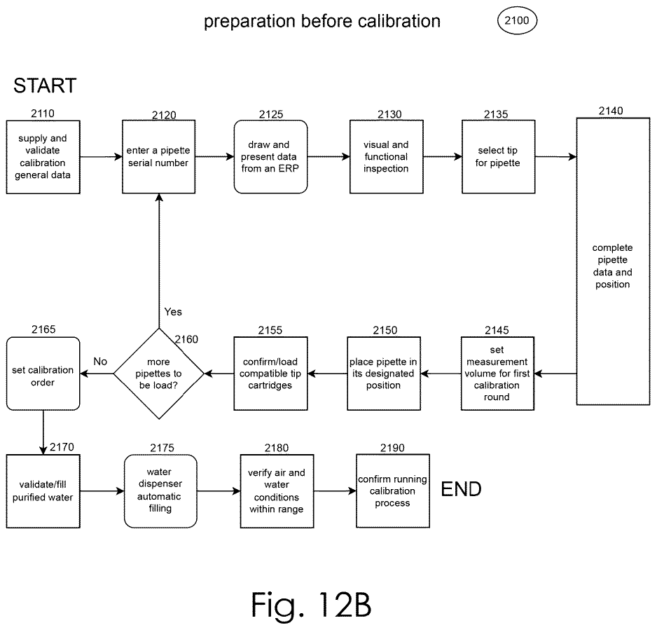

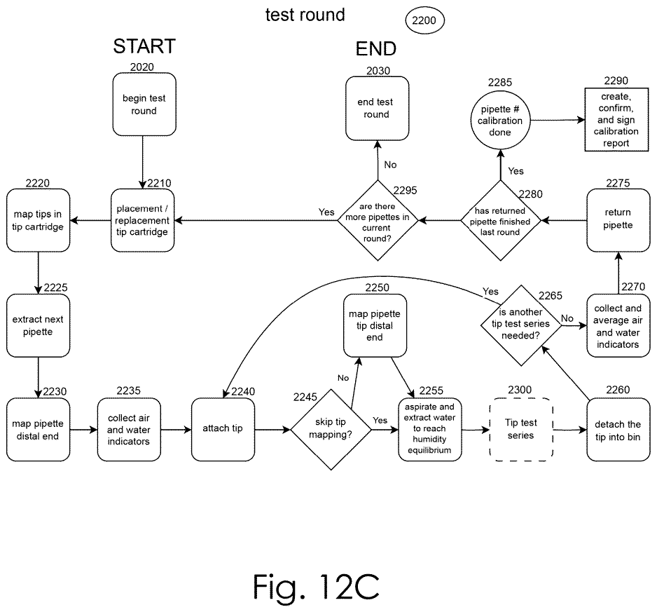

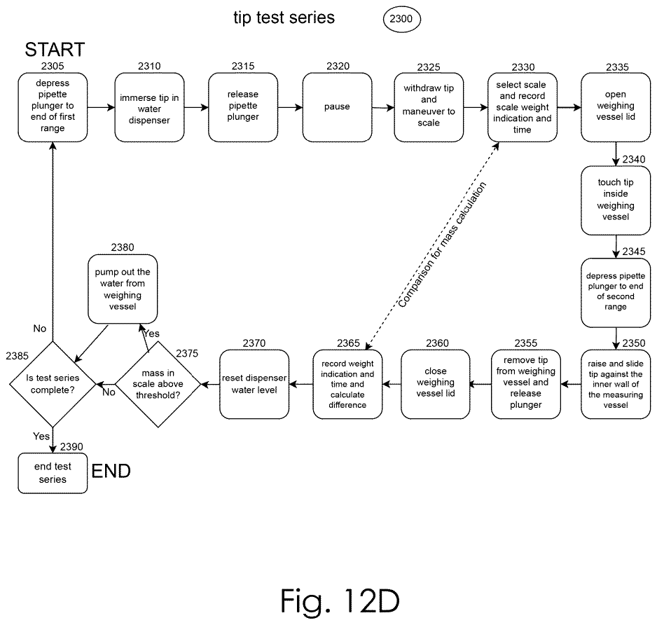

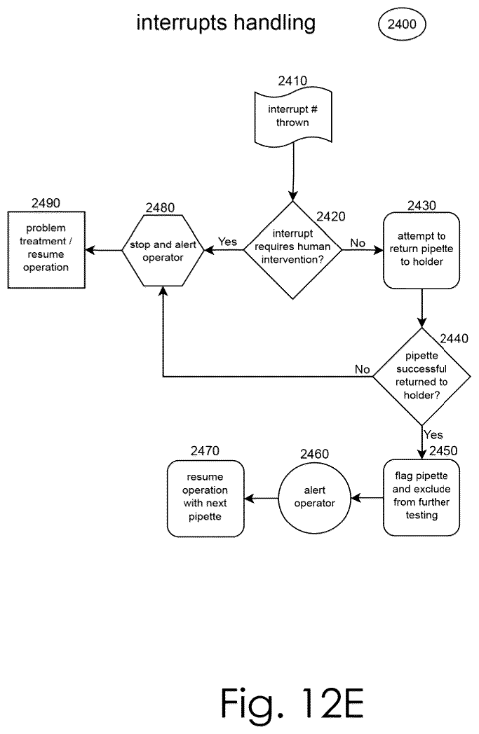

Reference is now made to FIGS. 12A-12E, which are schematic flowcharts illustrating methods for semi-automatic calibration of pipettes of substantially any air-displacement type, compatible with the International Standard ISO 8655-2:2022, according to embodiments of the disclosure. The flowchart presents a typical possible flow of operation for simplicity and clearness. A person skilled in the art may find many options for adding, subtracting, or changing the order of operations while complying with the applicable calibration standard (e.g., ISO 8655). For conciseness, the flowchart descriptions of operations are short and omit calculations and details available in the applicable calibration standard, the description of previous figures, those known in the art, and those assumed to be obvious for a person skilled in the art.

FIG. 12A includes, in addition to the flowchart, an explanatory graphical legend explaining the general meaning of each flowchart symbol.

FIG. 12A describes method 2000 for semi-automatic calibration of pipettes of substantially any size, shape, or operating mechanism. Method 2000 may comprise a stage of preparation before calibration (2100—FIG. 12A), initial evaporation test (2010; detailed below), followed by the beginning of the calibration round (2020), further detailed in FIG. 12C. Following the end of the calibration round (2030), if it is not the last round of calibration that was completed (2040), method 2000 may comprise stopping and alerting operator 1020 (2050). Method 2000 may comprise instructing operator 1020 to change the measurement volumes for all pipettes for the next calibration round as the applicable calibration standard dictates, and initiate the next calibration round (2060). If it is the last round of calibration that was completed (2040), method 2000 may comprise conducting a final evaporation test (2070; detailed below), returning the last tip cartridge 1900 from tip cartridge bay 400 to tip storage compartment 300 (2080), and completing the calibration (2090).

An evaporation test (2010, 2070) intends to determine the evaporation loss during each test cycle by calculating the difference between the mass of water in the weighing vessel at the beginning and at the end of the period equivalent to one test cycle time, with the lid of the weighing vessel open, but without making any delivery of liquid. Test cycle time is the average time between the lid opening and closing while testing a pipette. The results of said tests may be significant to correct the test results of tiny volume pipettes, using instructions in the applicable calibration standard. The evaporation test described above is designed to comply with ISO 8655-6:2022 and may need adjustments for other applicable calibration standards.

FIG. 12B describes method 2100 of preparation before calibration, typically executed primarily by operator 1020 at the beginning of a workday. Method 2100 may comprise supplying and validating calibration general data, e.g., location, names, and date (2110), and enter a pipette serial number by, e.g., barcode or QR-code scanning or typing (2120). Method 2100 may comprise drawing (and presenting) the pipette data from an ERP system (2125). Method 2100 may comprise inspecting the pipette visually and quickly check its functionality (2130) through user interface 800. Method 2100 may comprise selecting an appropriate tip (2135) from an available set, typically described in a database, adding a new type of tip by typing, or extracting the tip type from the ERP system and validating it.

Method 2100 may comprise validating and completing collection of pipette data relevant to the calibration process (2140). For example, such relevant data entry may be the position of the pipette in pipette holder 100, serial number of the pipette, manufacturer name, model type, customer's name, customer address, next calibration date, device volume range, measurement units, measurement volumes, repetition per volume calibrated, process description, calibration specification, reviewing standards document, reviewing/preparing conclusions, and added remarks. Method 2100 may comprise extracting such data from an ERP system, or allowing operator 1020 to type some, or allowing controller 700 to suggest some. For example, if controller 700 is aware of the set of pipettes in advance, it may be programmed to suggest optimal locations for the different pipettes to minimize rotation of pipette holder 100 and changes of tip cartridges 1900.

Method 2100 may comprise setting the measurement volume for the first calibration round (2145), placing the pipette in its designated position (2150) on the pipette holder 100, confirming the existence of at least one compatible tip cartridge 1900 in tip storage compartment 300 (2155), and then if any other pipettes are waiting to be loaded and there is at least one free space on pipette holder 100 (2160), continuing to the next pipette (2120) and repeating operations 2120 to 2155. After loading the complete pipette set, method 2100 may comprise setting the calibration order to minimize tip cartridge changes (2165), e.g., via controller 700 or manually by operator 1020. That is, to finish calibration of one type of pipettes and thus one type of respective tips, before continuing to the next type.

Method 2100 may comprise filling purified water in water container 1100 or validating water container 1100 is filled (2170) and, after confirmation, activating automatic water filling in water dispenser 500 (2175), e.g., via pumps. Method 2100 may comprise verifying that the air and water conditions measured within calibration system 1000, are within the permitted ranges (2180) and confirm running the calibration process (2190).

FIG. 12C describes method 2200, consisting of one test round executed primarily automatically by calibration system 1000 and controlled by controller 700. Following the initiation of a calibration round (2020) according to method 2000, method 2200 comprises validating that tip cartridge 1900 is appropriate for the next tested pipette 1800, is correctly placed in tip cartridge bay 400, and contains at least one tip (2210). If that validation fails, method 2200 places or replaces tip cartridge 1900 using robotic arm 200. If tip cartridge 1900 is empty, robotic arm 200 may dump it into bin 1200. If tip cartridge 1900 is not empty, robotic arm 200 may return it to tip storage compartment 300 and convey an appropriate tip cartridge 1900 from tip storage compartment 300 to tip cartridge bay 400. When robotic arm 200 extracts tip cartridge 1900 from tip storage compartment 300 it may slightly lift it above stopper 310, before pulling out. When robotic arm 200 inserts tip cartridge 1900 into tip storage 300 it may first push it in, optionally pushing up one or more tip cartridges waiting in line the same cell, and then slightly lower it behind stopper 310.

Method 2200 may further comprise mapping the tips in tip cartridge bay 400 (2220), possibly using camera 1700, possibly in conjunction with stored data. Method 2200 may comprise placing the next tested pipette 1800 in designated location 111 using pipette holder 100 and extracting the pipette using robotic arm 200 (2225). Method 2200 may comprise mapping the location of the pipette 1800 distal end relative to the robotic arm 200 (2230), possibly using sensing unit 900, and correcting the orientation of pipette 1800 accordingly. Method 2200 may comprise reading and storing measurements of environmental indicators within calibration system 1000, like air temperature, air humidity, and barometric pressure and water quality indicators like water temperature and conductivity (2235). The environmental measured data may be collected using environmental sensors 1500 and water quality sensors 1600.

Method 2200 may comprise attaching a tip to pipette 1800 (2240) of those mapped in tip cartridge 1900 stationed at tip cartridge bay 400 by pushing the distal end of pipette 1800 into a predetermined corresponding tip and possibly turning the pipette inside the tip to ensure complete connection between the tip and the pipette. In case tip cartridge 1900 is empty, method 2200 may comprise replacing the empty tip cartridge 1900 in accordance with the description of step 2210 above. In case pipette 1800 is held by gripper 202 and it is not possible to handle tip cartridge 1900 concurrently, method 2200 may comprise temporarily returning tested pipette 1800 to pipette holder 100 at designated location 111 using robotic arm 200, replacing the tip cartridge 1900, extracting tested pipette 1800, and mapping it again as described in steps 2225 and 2230.

In other embodiments, method 2200 may comprise checking in advance in step 2210 and avoiding using tip cartridge 1900 if it contains less tips than are expected to be used. In some cases, further optimizations may be implemented by leaving some pipettes with a fresh tip for the next round, when method 2200 comprises returning those pipettes to pipette holder 100.

Method 2200 may comprise mapping location and orientation of the distal end of pipette 1800 relative to the robotic arm 200 (2250), possibly using sensing unit 900, and correcting pipette 1800 orientation accordingly, if required. In some cases, skipping (2245) this mapping process (2250) may save time if it is not the first tip attached to pipette 1800 while it is attached to robotic arm 200. With discretion, such skipping (2245) may be possible in some embodiments. Method 2200 may comprise aspirating and extracting water five times into and out of pipette 1800 tip and from and into water dispenser 500 to reach humidity equilibrium in the tip (2255), as required by calibration standard ISO 8655-6:2022. Other applicable calibration standards may require different procedures. Method 2200 may then comprise executing method 2300 for a series of tests with the same tip (FIG. 12D). Following the completion of method 2300, method 2200 may comprise detaching the tip off pipette 1800 and into bin 1200 (2260).

If another tip test series is needed (2265), method 2200 may comprise attaching another tip (2240) and continuing accordingly. Calibration standard ISO 8655-6:2022 requires at least two tip test series of at least five measurements each. However, method 2200 may comprise performing a third series if there is a deviation above some preset thresholds in the average or dispersion between the two series of measurements. For example, the threshold may be having the two averages differ more than the standard deviation of all measures in the first two series. Many other statistical tests are known in the art, and the specific test and parameters may change following different standards, manufacturers, and customer requirements.

The third series should conform to and be more similar with one of the first two series, as experience shows faulty tips usually result from an external impact after production, making it a rare event with unique results. Having such conformity or similarity means the other series has a systematic error and must be eliminated (see: Reichenbächer, Manfred, and Jürgen W. Einax. Challenges in Analytical Quality Assurance. Springer Science & Business Media, 2011. Chapter 2-Types of Errors in Instrumental Analysis.). Following other applicable calibration standards may need adjustments to this procedure.

If no other tip test series is needed (2265), method 2200 may comprise reading data measurements of environmental and water quality indicators and calculating the averages with the previous results (2270; previous results in operation 2235). Method 2200 may comprise using those averages in the calibration evaluation process.

Method 2200 may further comprise returning the tested pipette 1800 to pipette holder 100 at designated location 111 using robotic arm 200 (2275). If the returned pipette 1800 finished its last round of testing (2280) without stopping the automatic process, method 2200 may comprise conveying or displaying an alert to operator 1020 (2285) through user interface 800 or other means. Consequently, and asynchronously, method 2200 may comprise instructing operator 1020 to inspect a completed pipette calibration report that may be produced by controller 700 based on normative evaluation methods, and confirm the report with a signature (2290). Method 2200 may comprise producing a report for every complete pipette calibration, even if the calibration fails.

Whether the returned pipette 1800 finished its last round of tests (2280) or not, if there are more pipettes in the current round (2295), method 2200 may comprise initiating testing of the next pipette (2210); otherwise, the test round ends (2030).

FIG. 12D describes method 2300, consisting of one tip test series executed automatically by calibration system 1000 and controlled by controller 700. Method 2300 may comprise depressing pipette plunger 1830 to the end of the first range (2305). Robotic arm 200 may push pipette plunger 1830 by extending accurate linear actuator 222 and extendable finger 224. Method 2300 may comprise immersing the tip vertically in water dispenser 500 to an appropriate immersion depth (2310), as indicated by the applicable standard for the relevant pipette volume. Method 2300 may comprise releasing the pipette plunger (2315) and pausing according to a predefined waiting time (2320), as indicated by the applicable standard for the relevant pipette volume. Method 2300 may comprise using robotic arm 200 with smooth and relatively slow movement to withdraw the tip vertically from water dispenser 500 (2325) and maneuver it towards scale system 600.

Method 2300 may comprise selecting the relevant scale following guidelines in the applicable standard, weighing and recording the current weight indication of the relevant scale, recording the time (2330), and opening the weighing vessel lid, if such is present (2335).

It should be noted that method 2300 allows scale selection based on measured volume (i.e., the water volume aspirated by the pipette), potentially exceeding current standards requirements. This may achieve more precise results and reduce uncertainty compared to current standards requirements. It is important to note that adherence to relevant standards permitting such exacerbation should be ensured.

Method 2300 may comprise using robotic arm 200 with smooth and slow movement to maneuver pipette 1800 to touch the tip inside the weighing vessel, e.g., beaker 610, at an angle between, e.g., 30° and 45° and a depth of about 10 mm or deeper (2340). Method 2300 may comprise depressing pipette plunger 1830 to the end of the second range (2345) to deliver the water carried by the pipette into the weighing vessel and to expel the last drop by pushing out the water drops that stay at the distal end of the tip as a result of water surface tension, as explained hereinabove with respect to FIGS. 8A-8C (i.e., blow-out feature).

Method 2300 may comprise raising the tip between 8 mm and 10 mm and sliding along the inner wall of the weighing vessel to remove any droplets at or around the tip orifice (2350). Method 2300 may comprise removing the tip from the weighing vessel, and may then further comprise releasing the plunger (2355), closing the lid of the weighing vessel (2360), recording the time and recording the updated weight indication of the relevant scale, and calculating the difference from the previous weight indication results (2365; previous results 2330).

Method 2300 may further comprise resetting the water level of water dispenser 500 (2370). In some embodiments, method 2300 may comprise resetting the water level by measuring and supplying more water and re-measuring the water level if needed. In other embodiments, method 2300 may comprise resetting the water level by pumping more water than was extracted in the last tip measurement, from stabilizing water container 504 to stabilized water container 502, and letting gravitation to naturally adjust water level in stabilized water container 502.

If the mass in one of the scales is above a certain weight threshold, e.g., half the maximum range (2375), method 2300 may comprise pumping out the water from the weighing vessel, e.g., beaker 610 (2380). If this series' predetermined number of measurements is complete (2385), method 2300 may comprise ending the test series (2390). Otherwise, method 2300 may comprise returning to operation (2305) and depressing the pipette plunger 1830 to end of first range to begin a new test sequence.

FIG. 12E describes method 2400, which handles external and internal interruptions. Method 2400 is mostly executed automatically by calibration system 1000 and controlled by controller 700, unless a human needs to resolve the issue, in which case method 2400 is performed by operator 1020.

Method 2400 may begin when any part of calibration system 1000 creates an interruption following an unwanted event that was previously anticipated as possible and was designated with a proper tool to detect it (2410). In some embodiments, such events may be, among others, issues concerning non-standard air temperature, relative humidity, or barometric pressure being too low or too high, water temperature being too low or too high, water conductivity being too high, any malfunction with any of the following: electric motor, sensor, pump, drainage, actuator, camera, robotic arm, gripper, vacuum gripper, scale, or electricity failure, detecting low pneumatic air pressure, bin is full, no purified water left in water container 1100, no appropriate tip in tip storage compartment 300 or tip cartridge bay 400, any measurement out of the allowed and/or predefined range, pipette unable to attach or release a tip, pipette plunger failure or tip release button failure, door open of calibration system 1000, collision of robotic arm 200, unsupervised sudden detachment of tip cartridge from robotic arm 200, of a tip from a pipette during the calibration process, or pipette detached unexpectedly from robotic arm 200 or pipette holder 100, tip cartridge unable to be returned to the tip storage compartment 300 or to be properly placed within tip cartridge bay 400. The above list is merely an example, as other possible interruptions are implementation-specific.

If the interrupt requires human intervention (2420), method 2400 may comprise stopping the execution of method 2000 and conveying an alert to operator 1020 through user interface 800 or any other means (2480). If operator 1020 treats the problem successfully, method 2400 may comprise resuming calibration operation according to method 2000 (2490).

Otherwise, if the interrupt may be handled automatically (2420), method 2400 may comprise attempting to return pipette 1800 to pipette holder 100 (2430). If this attempt is unsuccessful (2440), method 2400 may comprise stopping the execution of method 2000 and continuing as explained above, i.e., in operation (2480). If said attempt was successful (2440), method 2400 may comprise flagging, i.e., marking the relevant pipette 1800 as, e.g., ‘need further scrutiny’ and excluding it from further testing (2450). In this case, method 2400 may comprise conveying an alert or making it available to operator 1020, e.g., through user interface 800 or any other means that the pipette 1800 is returned to holder 100 and marked as ‘problematic’ (2460) without stopping the automatic process. Method 2400 may further comprise resuming the regular operation of method 2000 with the next pipette 1800 (2470).

It should be appreciated that the above-described methods and apparatus may be varied in many ways, including omitting or adding steps, changing the order of steps, and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure.

It will be appreciated by persons skilled in the art that the present disclosure is not limited to what has been particularly shown and described hereinabove. Rather the scope of the present disclosure is defined only by the claims, which follow.

I/We claim:

1. A method for calibration of a plurality of pipettes of any air-displacement type, compatible with the International Standard ISO 8655-6:2022, said method comprising:
(a) adjusting a first calibration volume in each of the plurality of pipettes, said adjusting is performed manually;
by an automated system:
(b) extracting a pipette from a pipette holder;
(c) attaching a corresponding tip to a pipette distal end;
(d) immersing a tip distal end into a water dispenser;
(e) aspirating water from the water dispenser into the tip according to the adjusted first calibration volume;
(f) extracting the water from the tip onto a scale;
(g) weighing the extracted water by the scale;
(h) repeating operations (d)-(g) for a predetermined number of times;
(i) after completion of operations (d)-(g) for the predetermined number of times, removing the tip from the pipette;
(j) calculating average volume of the water of operations (d)-(h) by a processor;
(k) repeating operations (c)-(j) for another predetermined number of times;
(l) returning pipette back to the pipette holder by the robotic arm; and
(m) repeating operations (b)-(l), by the robotic arm, until all of the plurality of pipettes are calibrated per the first calibration volume.

2. The method of claim 1, wherein the plurality of pipettes comprises at least 15 pipettes.

3. The method of claim 1, further comprising adjusting additional calibrating volumes in each of the plurality of pipettes, said adjusting is performed manually; and
repeating operations (b)-(l) until all of the plurality of pipettes are calibrated per the additional calibration volume.

4. The method of claim 1, further comprising collecting environmental data via sensors, said sensors comprising air temperature sensor, humidity sensor, air pressure sensor, water conductivity sensor, water temperature sensor, or any combination thereof;
and further comprising using the collected environmental data for the calculations of each pipetted water volume.

5. The method of claim 1, wherein the immersing a tip distal end into a water dispenser is done at a depth determined based on the first calibration volume and corresponding to a relevant ISO standard.

6. The method of claim 1, further comprising one or more of the following operations:
selecting one of two scales, based on the adjusted calibration volume, prior to operation (f);
mapping the pipette distal end location with respect to the robotic arm following operation (b) and prior operation (c);
determining tip distal end location with respect to the robotic arm following operation (c);
uploading pipette parameters per location in pipette holder, prior to operation (a);
placing a tip cartridge, by the robotic arm, at a cartridge bay, and fixating the cartridge at a specific location within the bay, via jaws that push the cartridge to a specific corner in the cartridge bay, prior to operation (b), further comprising returning said cartridge to its allocated cell in the tip storage compartment prior to placing a different cartridge in the cartridge bay;
extracting a tip cartridge from a corresponding cell of a tip storage compartment prior to placing the tip cartridge at a cartridge bay;
extracting an empty tip cartridge from a cartridge bay and replacing it with a new cartridge carrying the type of tip that corresponds to the type of pipette extracted in operation (b); and
refilling the water dispenser with water after operation (e).

7. The method of claim 1, wherein the aspirating water from the water dispenser into the tip comprises depressing a pipette plunger to end of a first range and controlling application of a depressing force on the pipette plunger by a force sensor, and releasing the pipette plunger to displace air from the pipette with water from the water dispenser,
further comprising wiping excess water droplets off the external side of the pipette tip against a wall situated above the water basin.

8. The method of claim 1, wherein the extracting the water from the tip onto a scale comprises depressing a pipette plunger to end of a second range and controlling application of a force on the pipette plunger to displace water from the pipette with air, by a pressure sensor, and drawing the distal end of the tip along an inner wall of a weighing vessel positioned on the scale.

9. The method of claim 1, wherein the repeating operations (e)-(g) for a predetermined number of times comprises repeating operations (e)-(g) five times.

10. The method of claim 1, wherein after the removing the tip from the pipette, repeating operations (c)-(g), thereby completing at least ten measurements per each calibration volume.

11. The method of claim 1, wherein the extracting of a pipette from a pipette holder comprises identifying the pipette by a location of the pipette in the pipette holder.

12. The method of claim 1, wherein following operation (k), the calculated average volume of the water per each batch of measurements of the predetermined number of times, are compared, and if a difference between two calculated average volumes of the water is above a predefined threshold, the method comprises repeating operations (d)-(j) for a third predetermined number of times, and by comparing each of the first two calculated average volume of water to the third calculated average volume of water, determining which of the first two batches of measurements is related to a faulty tip and which is to an intact tip.

13. A system for calibration of a plurality of pipettes of any air-displacement type, compatible with the International Standard ISO 8655-6:2022, said system comprising:
a pipette holder configured to carry a plurality of pipettes of any air-displacement type, each of said plurality of pipettes adjusted to aspirate water of a specific calibration volume;
a robotic arm comprising a gripper configured to hold any air-displacement type of pipette, said gripper comprising two moveable arms, each having a non-rigid face that comes in contact with a pipette, wherein the moveable arms are configured to contract for gripping a pipette in between the two non-rigid faces of the moveable arms, and to expand for releasing the pipette from the gripper;
a water dispenser;
at least one scale for weighing water extracted from the water dispenser by each of the plurality of pipettes;
a control system; and
a user interface configured to display information related to calibration.

14. The system of claim 13, wherein the plurality of pipettes comprises at least 15 pipettes.

15. The system of claim 13, further comprising one or more of the following:
a tip storage compartment comprising multiple different sized cells, each cell comprising at least one tip cartridge, wherein the different sized cells are configured to carry different sized tip cartridges for holding a different size of tips;
a tip storage compartment comprising multiple different sized cells, each cell comprising at least one tip cartridge, wherein the tip storage compartment has an arched shape, such that distance of the robotic arm from each cell of the tip storage compartment is similar;
a tip storage compartment comprising multiple different sized cells, each cell comprising at least one tip cartridge, wherein each cell is positioned at an angle with respect to a floor of the system, to enable sliding of a tip cartridge towards a cell entrance;
a tip storage compartment comprising multiple different sized cells, each cell comprising at least one tip cartridge, wherein at least one cell entrance comprises a stopper, said stopper comprising a raised extension of a bottom side of the cell, to prevent the tip cartridge from slipping out of the cell entrance;
a tip storage compartment comprising multiple different sized cells, each cell comprising at least one tip cartridge, wherein each cell comprises rails positioned on opposite sides of a bottom side of the cell, to enable the tip cartridge within the cell to slide on top of the rails and reach a cell entrance; and
a tip cartridge bay comprising at least two jaws that push the cartridge to a specific corner in the cartridge bay, to thereby fixate the cartridge at a specific location within the cartridge bay.

16. The system of claim 13, further comprising one or more of the following:
the pipette holder is a carousel configured to carry at least 15 pipettes of any air-displacement type;
the pipette holder comprises a plurality of hangers per each of the plurality of pipettes, onto which the pipettes may be hanged;
the pipette holder comprises a motor configured to rotate the carousel pipette holder;
the robotic arm is a six-axis articulated robotic arm;
the robotic arm further comprises a cylinder configured to press on a tip release button of the pipette for releasing a tip from the pipette;
the robotic arm further comprises an accurate linear actuator and a force sensor configured to control application of a force applied by the accurate linear actuator on a pipette plunger for aspirating water from the water basin and for extracting the aspirated water into the at least one scale;
the robotic arm further comprises a vacuum gripper configured to carry a tip cartridge by attaching the vacuum gripper to one face of the tip cartridge, via vacuum;
the water dispenser comprises a drain opening for removing excess water, said water dispenser refilled to maintain a specific water level before every water extraction from the water dispenser;
the at least one scale comprises two scales that differ in scale resolution and range, each configured to weigh a different water calibration volume;
a water drainage system for draining water from the at least one scale to ensure the water vessel over the scale is not overfilled with water by the repetitive water extraction into the vessel, wherein said drainage system is deployed to the water vessel on demand and retracted when unused to prevent waterdrops that may affect the measurement accuracy; and
the controller is configured to control operation of the robotic arm.

17. The system of claim 13, wherein the user interface provides notifications to the user, wherein the notifications comprise notifications of end of calibration of the plurality of pipettes, malfunction of the calibration process, water level in a water container is above or below a predetermined threshold, environmental conditions are above a predetermined threshold, pipette is not grasped by a robotic arm, tip is not found after attachment to pipette, pipette holder is not moving, water emptying system malfunction, water purity does not meet predetermined conditions, missing tip per pipette in the tip storage compartment, operator door is open, end of batch and operator is required to adjust a new calibration volume, end of final round, report signature is missing, or any combination thereof.

18. The system of claim 13, further comprising a sensing unit used to determine location of a pipette and tip distal end relative to the robotic arm, wherein said sensing unit comprises a beam emitter and a photoelectric sensor.

19. A tray for connecting to a tip cartridge, said tray comprising:
a horizontal sheet connected to a longitudinal sheet to create an L shape, wherein the horizontal sheet of the L shaped tray is connected to a bottom end of a tip cartridge, and the longitudinal sheet of the L shaped tray is in contact with a side of the tip cartridge,
further wherein the longitudinal sheet is flat at least on its external side, such to enable grip of the L shaped tray by vacuum, thereby to enable any type and size of tip cartridge to be carried by a vacuum gripper via the tray.

20. The tray of claim 19, wherein the tray comprises one or more of the following:
the horizontal sheet is flat and is configured to slide along corresponding rails of each cell of a tip storage compartment;
the horizontal sheet is connected to the bottom end of the tip cartridge via adhesive;
the longitudinal sheet is connected to the side of the tip cartridge via adhesive; and
the tray is made of plastic.
